(19) United States
(12) Patent Application Publication
(10) Pub. No.: US 2024/0179554 A1
(43) Pub. Date: May 30, 2024

(54) NW ASSISTANCE FOR MEASUREMENT AND MOBILITY ENHANCEMENT

(71) Applicant: QUALCOMM Incorporated, San Diego, CA (US)

(72) Inventors: Jing LEI, San Diego, CA (US); Yong LI, San Diego, CA (US); Konstantinos DIMOU, New York, NY (US)

(21) Appl. No.: 18/476,201

(22) Filed: Sep. 27, 2023

Related U.S. Application Data
(60) Provisional application No. 63/385,389, filed on Nov. 29, 2022.

(51) Int. Cl. H04W 24/10; H04W 36/00; H04W 36/32; H04W 64/00

(52) U.S. Cl. CPC H04W 24/10; H04W 36/0058; H04W 36/0069; H04W 36/324; H04W 64/006

(57) ABSTRACT

A method for wireless communication at a source node and related apparatus are provided. In the method, the source node receives a user equipment (UE) request for an on-demand allocation of mobility measurement resources or mobility reporting resources for a UE, and provides a configuration, allocation, or activation for the mobility measurement resources or the mobility reporting resources in response to the UE request.

### CROSS REFERENCE TO RELATED APPLICATION(S)

This application claims the benefit of and priority to U.S. Provisional Application Ser. No. 63/385,389, entitled “NW ASSISTANCE FOR MEASUREMENT AND MOBILITY ENHANCEMENT” and filed on Nov. 29, 2022, which is expressly incorporated by reference herein in its entirety.

### TECHNICAL FIELD

The present disclosure relates generally to communication systems, and more particularly, to network assistance for measurement and mobility enhancement in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type c communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a source node. The apparatus may include memory and at least one processor coupled to the memory. Based at least in part on information stored in the memory, the at least one processor may be configured to receive a UE request for an on-demand allocation of mobility measurement resources or mobility reporting resources for a UE; and provide a configuration, allocation, or activation for the mobility measurement resources or the mobility reporting resources in response to the UE request.

In an aspect of the disclosure, a method, a computer-readable medium, and an apparatus are provided for wireless communication at a user equipment (UE). The apparatus may include memory and at least one processor coupled to the memory. Based at least in part on information stored in the memory, at least one processor may be configured to transmit a UE request for an on-demand allocation of mobility measurement resources or mobility reporting resources for the UE; and receive a configuration, allocation, or activation for the mobility measurement resources or the mobility reporting resources in response to the UE request.

To the accomplishment of the foregoing and related ends, one or more aspects may include the features hereinafter fully described and particularly pointed out in the claims. The following description and the drawings set forth in detail certain illustrative features of one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example UE mobility configurations.

FIG. 5 is a diagram illustrating conditional handover.

FIG. 6 is a diagram illustrating an example BWP switching in accordance with various aspects of the present disclosure.

FIG. 7 is a diagram illustrating an example measurement model.

FIG. 8 is a call flow diagram illustrating the network assistance for on-demand RS transmission/activation in accordance with various aspects of the present disclosure.

FIG. 9 is a call flow diagram illustrating the network-assisted timer adaptation for BWP switching and mobility in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a source node in accordance with various aspects of the present disclosure.

FIG. 12 is a flowchart illustrating methods of wireless communication at a source node in accordance with various aspects of the present disclosure.

FIG. 13 is a flowchart illustrating methods of wireless communication at a source node in accordance with various aspects of the present disclosure.

FIG. 14 is a flowchart illustrating methods of wireless communication at a network entity in accordance with various aspects of the present disclosure.

FIG. 15 is a flowchart illustrating methods of wireless communication at a UE in accordance with various aspects of the present disclosure.

FIG. 16 is a flowchart illustrating methods of wireless communication at a UE in accordance with various aspects of the present disclosure.

FIG. 17 is a flowchart illustrating methods of wireless communication at a UE in accordance with various aspects of the present disclosure.

FIG. 18 is a diagram illustrating an example of a hardware implementation for an example apparatus and/or network entity.

FIG. 19 is a diagram illustrating an example of a hardware implementation for an example network entity.

### DETAILED DESCRIPTION

In wireless communication, a user equipment (UE) may switch its connection from one cell (e.g., the source cell) to another cell (e.g., the target cell) based on measurements on a reference signal (RS), a process known as the handover (HO) operation. HO failure, which may occur due to various reasons such as the source cell not receiving measurement reports or the HO command not reaching the UE, may have a significant impact on network performance. One approach to address this issue is conditional handover (CHO), which improves mobility robustness by preparing multiple candidate target cells in advance. While CHO enhances the robustness and reliability of HO, it also increases signaling overhead, thereby reducing the network's spectral and energy efficiency. Additionally, bandwidth part (BWP) switching during HO can worse latency and power issues of HO. Example aspects presented herein provide methods and apparatus for network (NW) assistance for on-demand reference signal (RS) transmission/activation and duplication of mobility signaling by the network. The NW assistance enables on-demand transmission or activation of aperiodic or periodic downlink (DL) RS configured for layer 1 (L1) or layer 3 (L3) measurements of source and/or target cells to facilitate the HO operation.

Various aspects relate generally to wireless communication. Some aspects more specifically relate to network assistance for measurement and mobility enhancement in wireless communication. In some examples, a source node of the network may receive a UE request for an on-demand allocation of mobility measurement resources or mobility reporting resources for the UE; and provide a configuration, allocation, or activation for the mobility measurement resources or the mobility reporting resources in response to the UE request. In some examples, a source node of the network may receive a request from a source node for a downlink reference signal configured for layer 1 (L1), layer 2 (L2) or layer 3 (L3) measurement at the UE; and provide a reference signal configuration to the source node for the UE in response to the request. In some examples, a network entity may receive mobility measurement information from a UE that triggers or indicates a cell handover, a change of the primary cell in dual connectivity, a transmission reception point (TRP) switch, or a beam switch; and provide an indication of duplicate mobility signaling indicating the cell handover, the change of primary cell, the TRP switch, or the beam switch.

Particular aspects of the subject matter described in this disclosure can be implemented to realize one or more of the following potential advantages. In some examples, by providing a configuration, allocation, or activation for the mobility measurement resources or the mobility reporting resources in response to a UE request for an on-demand allocation of mobility measurement resources or mobility reporting resources, or by providing a reference signal configuration to a source node for the UE in response to the request from the source node for a downlink reference signal configured for L1, L2, or L3 measurement, the described techniques may be used to mitigate the potential increase of latency/overhead/power incurred by un-desirable BWP switching during a handover (HO), including a network-initiated HO, a conditional handover (CHO), a conditional primary serving cell (PSCell) change (CPC), etc. The on-demand resource may allow network to reserve less resources for UE mobility and increase the resources based on UE request, thus reduces network signaling and power overhead. Based on the measurement conditions, UE may request additional RS resources for better measurements and request for additional BWP timer mechanism to improve the HO success avoiding inactivity timer expiring. The BWP inactivity timer adaptation signaling helps avoid BWP switching during handover.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well-known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

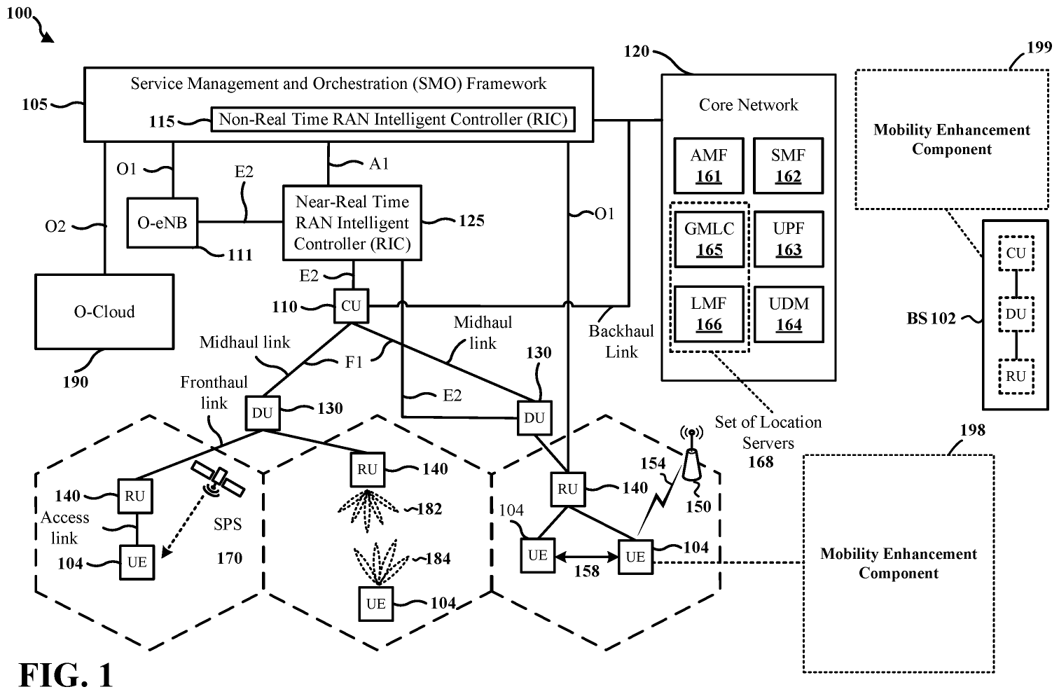

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a mobility enhancement component 198. In some aspects, the mobility enhancement component 198 may be configured to transmit a UE request for an on-demand allocation of mobility measurement resources or mobility reporting resources for the UE; and receive a configuration, allocation, or activation for the mobility measurement resources or the mobility reporting resources in response to the UE request. In some aspects, the mobility enhancement component 198 may be configured to transmit mobility measurement information to a network node that triggers or indicates a cell handover, a change of primary cell in dual connectivity, a TRP switch, or a beam switch; and receive an indication of duplicate mobility signaling indicating the cell handover, the change of primary cell, the TRP switch, or the beam switch. In certain aspects, the base station 102 may include a mobility enhancement component 199. In some aspects, the mobility enhancement component 199 may be configured to receive a UE request for an on-demand allocation of mobility measurement resources or mobility reporting resources for a UE; and provide a configuration, allocation, or activation for the mobility measurement resources or the mobility reporting resources in response to the UE request. In some aspects, the mobility enhancement component 199 may be configured to receive a request from a source node for a downlink reference signal configured for L1 or L3 measurement at a UE; and provide a reference signal configuration to the source node for the UE in response to the request. In some aspects, the mobility enhancement component 199 may be configured to receive mobility measurement information from a UE that triggers or indicates a cell handover, a change of primary cell in dual connectivity, a TRP switch, or a beam switch; and provide an indication of duplicate mobility signaling indicating the cell handover, the change of primary cell, the TRP switch, or the beam switch. Although the following description may be focused on 5G NR, the concepts described herein may be applicable to other similar areas, such as LTE, LTE-A, CDMA, GSM, and other wireless technologies.

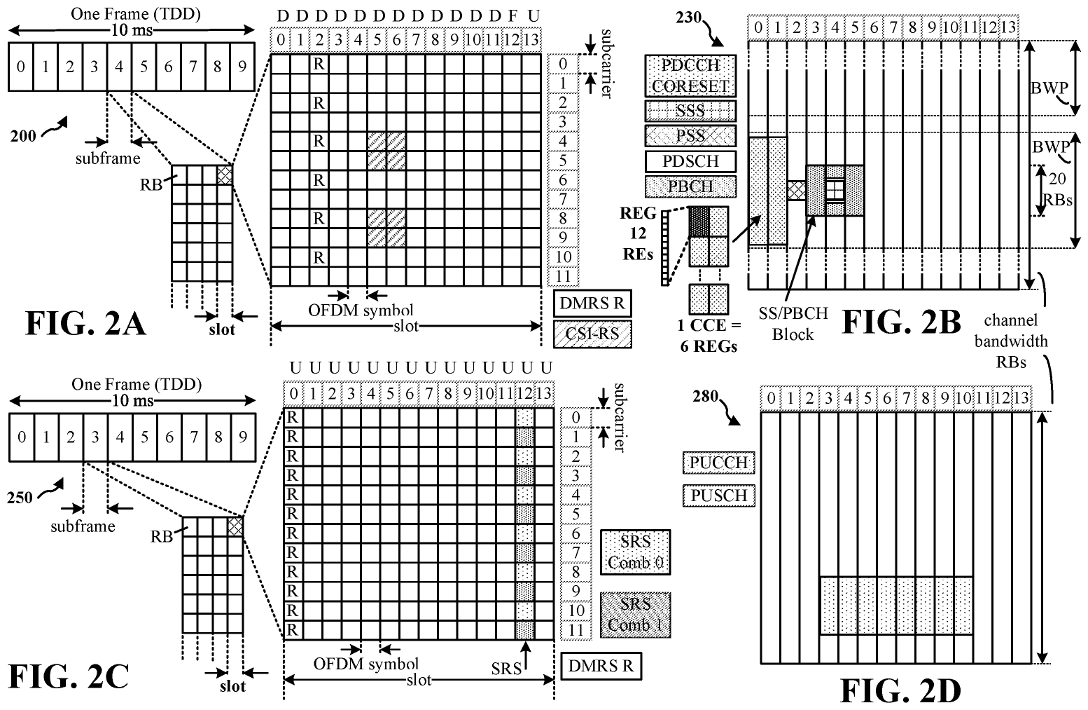

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number. The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

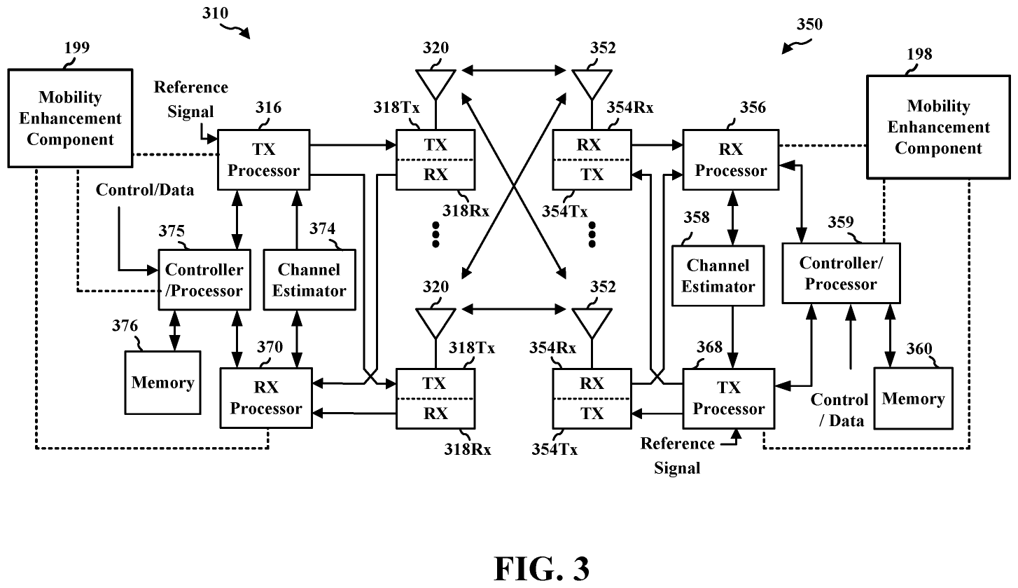

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving. rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the mobility enhancement component 198 of FIG. 1.

At least one of the TX processor 316, the RX processor 370, and the controller/processor 375 may be configured to perform aspects in connection with the mobility enhancement component 199 of FIG. 1.

Wireless communication networks, such as a 5G NR network, may be designed to include UE mobility. A UE may receive a command(s), RRC configuration(s), or RRC reconfiguration(s) from a network for mobility operations. For example, a UE may make measurements related to a source node and a target node(s) and provide such measurements in a report to the source node, which may in turn initiate or trigger cell-level mobility, TRP-level mobility, or beam-level mobility. In some aspects, the mobility may include a handover (HO) operation to a target node from a source node, by way of example. HO failure may occur in some cases when communications between the UE and the source node do not complete. Compounding this issue, the UE may be configured to perform a BWP switch from operating in an active DL BWP on the source node to a default DL BWP. In some aspects, the BWP switch may be triggered by, or based on, the expiration of an inactivity timer. The default DL BWP may provide power savings for the UE, and the UE may transition to the default DL BWP after a period of inactivity in order to save power. In such configurations, the HO command from the source node may be transmitted by the network in the active DL BWP, while the UE has switched to the default DL BWP. The network side operations for a HO may include multiple processing steps and may require some time to complete. In such cases, the UE may miss the HO command entirely, as well as the opportunity for a network-initiated HO.

In other words, latency in the network-side response for mobility operations may be problematic with respect to mobility and power saving. For example, in network-initiated mobility procedures, such as HO and inter-node (e.g., cell, TRP, etc.) beam switching, it may take time for a UE to receive the reconfiguration signaling via RRC (e.g., ‘RRCReconfiguration’) after sending a measurement report to the source node that triggers the reconfiguration, due, for example, to the multiple processing steps and signaling exchange sequentially performed by the source node and the target node. For instance, a source node may process the UE's measurement reports for mobility, send a request for HO/beam switching to a target node based on the outcome of measurement reports, receive an acknowledgment (ACK) to the request for HO/beam switching from the target node, and send the reconfiguration signaling via RRC (e.g., “RRCReconfiguration”) message to the UE. Similarly, a target node may receive a request for HO/beam switching from the source node, perform admission control and provide the new RRC configurations as part of the acknowledgement to the request for HO/beam switching, and transmit the acknowledgement to the source node. Regarding increased latency/power/signaling overhead that may result from BWP switching(s), if a UE is configured with a BWP inactivity timer for power saving on the source node, and the BWP inactivity timer expires before the UE receives a command for HO/beam switching (e.g., via DCI or RRC (“RRCReconfiguration”)), the UE may fall back to the default DL BWP and miss the opportunity for the network-initiated mobility. Additionally, because the link quality is unlikely to improve in the default DL BWP, the UE may be forced to attempt an RRC re-establishment, or to initiate cell selection/re-selection after releasing its RRC connection with the source node as a result of RRC re-establishment failure. Moreover, PRACH resources may not be configured in a UL BWP associated with the default DL BWP or the active DL BWP for the UE, which may force the UE to switch BWPs again for RACH.

Some mobility enhancement schemes (e.g., dual active protocol stack (DAPS) and conditional HO (CHO)) may improve the robustness and reduce the latency of mobility in some scenarios, yet may have higher implementation complexity for the network/UE (dual connectivity to source and target nodes), or may consume more network resources (e.g., early data forwarding and RACH resource reservation across multiple target nodes). There may also be additional challenges for mobility in wireless communication such as 5GA/6G. For instance, with network-side densification and new spectrum opened for 5GA/6G, as well as expanded support for new devices with higher speeds, frequent cell-level/beam-level mobility may be more frequent for the UE and/or the network.

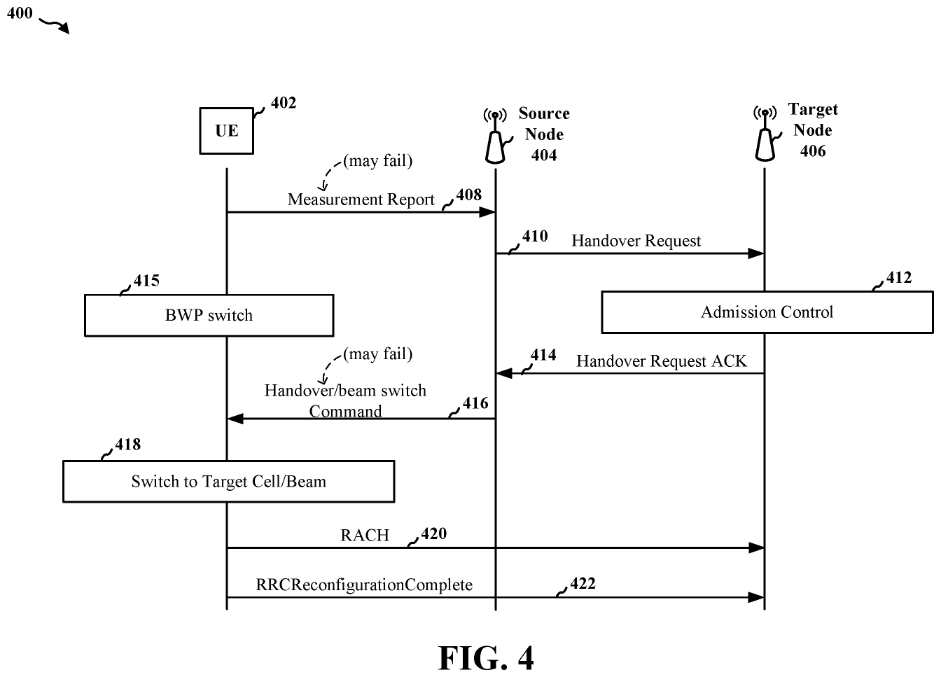

FIG. 4 is a diagram 400 illustrating example UE mobility configurations, in various aspects. In aspects, diagram 400 may be for cell-level and/or beam-level mobility of a UE 402 in the RRC-connected state (e.g., “RRC_CONNECTED”) with a source node 404 (e.g., a source base station or a portion thereof). As shown, cell-level/beam-level mobility of the UE 402 may be performed with respect to a target node 406 (e.g., a target base station or a portion thereof). The source node may be a source base station, and the target node may be a target base station, in some aspects. In other aspects, the source node may be a source TRP, and the target node may be a target TRP. The source and target TRP may be for the same base station or may be for different base stations. In some aspects, the first node may be a first component of a base station, and the second node may be a second component of the same base station or of a different base station.

Network-side initiated mobility may apply to UEs in RRC-connected states, and may be categorized into cell-level and beam-level operations. Network-side initiated cell-level/beam-level mobility may be in response to the UE 402 sending measurement reports 408 to the source node 404. The UE 402 may make measurements of the source node 404 and/or the target node 406, e.g., by measurement reference signals on one or more beams from the source node and/or the target node, and provide a measurement report to the source node 404. If the source node 404 determines that the measurement report indicates a mobility operation should take place with the target node 406 (e.g., in response to the measurement for the source node being below a threshold, or the measurement for the target node being better than the measurement for the source node), the source node 404 may provide a HO request 410 to the target node 406. The target node 406 may then be configured to perform admission control 412 associated with the UE 402. On completion of the admission control 412, the target node 406 may provide a HO request acknowledgement (ACK) 414 to the source node 404, which may in turn provide a HO command 416 to the UE 402. The UE 402 may be configured to switch, at 418, to the indicated cell/beam of the target node 406 and as part of the mobility operation, a RACH process 420 may be performed by the UE 402 with the target node 406. When the RACH process 420 is complete, the UE 402 may then provide an indication that the RRC reconfiguration for the mobility operation switching is completed, at 422.

However, as noted above and as illustrated in diagram 400 of FIG. 4, HO failure may happen when measurement reports 408 of the UE do not reach the source cell, e.g., due to communication failure. In this example, the network is not aware that a condition has occurred that would trigger a node change, and does not initiate the handover. In other aspects, the HO failure may happen when a HO command 416 of the source cell does not reach the UE, e.g., due to communication failure, because the UE is not aware of the HO.

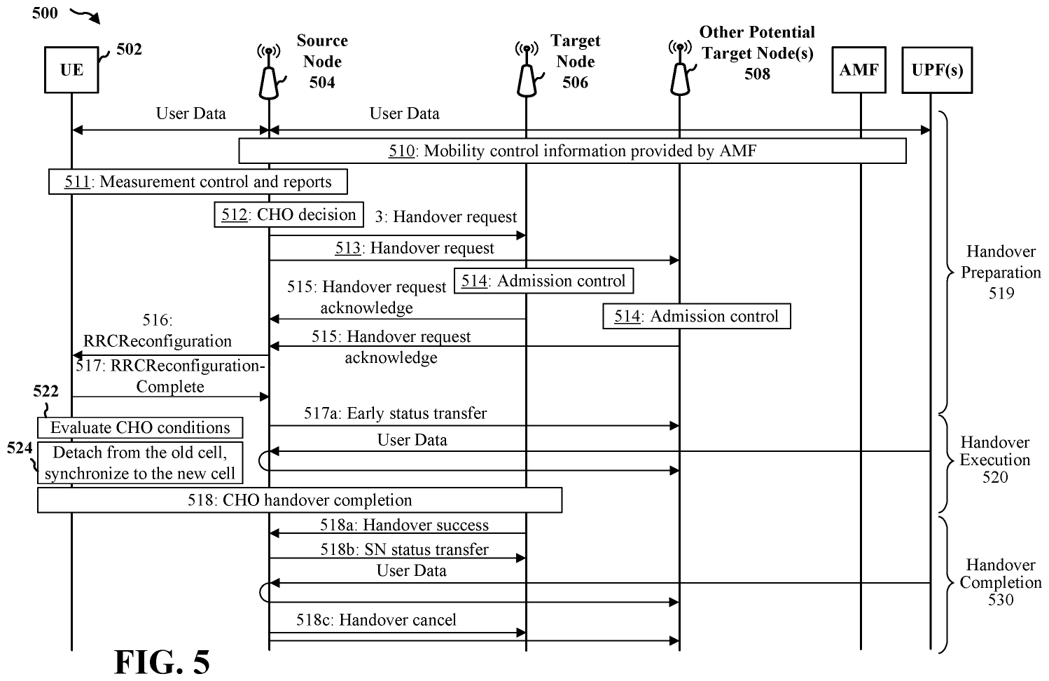

In some aspects, a UE may be configured for a conditional handover (CHO), and the UE may know to initiate the CHO when a measurement at the UE meets a configured condition to trigger the CHO. FIG. 5 is a diagram 500 illustrating an example communication flow for a conditional handover. As shown in FIG. 5, an example CHO process may include three stages: a handover preparation 519, a handover execution 520, and a handover completion 530. In the handover preparation 519, the source node 504 and candidate target nodes (506, 508) may receive, at 510, mobility control information provided by the AMF, and the UE 502 and the source node 504 may communicate, at 511, for measurement control and reports. The CHO decision may be made by the source node 504, at 512, for example. Upon making the CHO decision at 512, the source node 504 may send the handover request to the candidate target nodes (506, 508), at 513, and the candidate target nodes (506, 508) may perform, at 514, admission control and respond, at 515, to the source node 504 with handover request acknowledge. The source node 504 then may, at 516, send the UE 502 through RRC configuration (e.g., through “RRCReconfiguration” message) the list of candidate target nodes (e.g., 506, 508) and CHO trigger conditions, and the UE 502 may respond, at 517, with, for example, the “RRCReconfigurationComplete” message.

In the handover execution 520, the UE 502 may measure the candidate nodes (e.g., 506, 508) and evaluate the CHO trigger conditions at 522. When the CHO trigger condition is met for one of the candidate nodes (e.g., 506, 508), the UE 502 may, at 524, detach from the old node (i.e., the source node 506) and connect to the candidate target node that meets the CHO trigger condition (e.g., the target node 506).

In the handover completion 530, the target node that was newly connected to the UE (e.g., the target node 506) may send, at 518a, a handover success confirmation to the source node 504, and the source node 504 may transfer, at 518b, the source node status to the newly connected target node (e.g., 506). The same principle of CHO may be reused for the CPC in dual connectivity (DC). In some aspects, a handover may be canceled, such as shown at 518c.

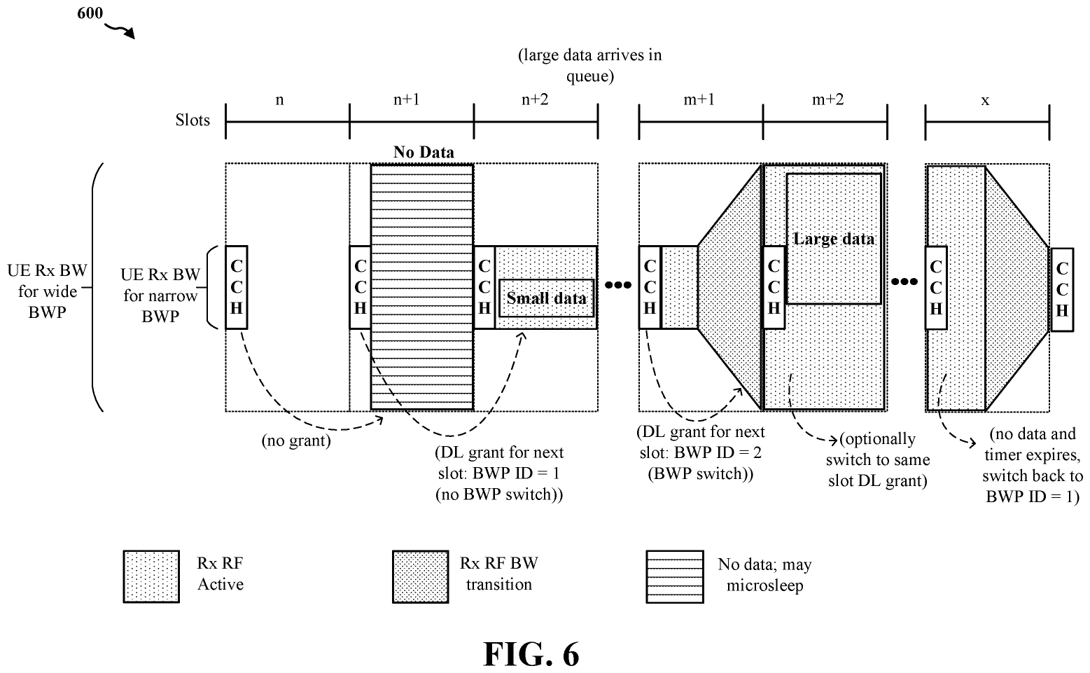

A UE may communicate with a network based on a BWP, which spans a portion of a total channel bandwidth configured for a cell. A UE may be configured with multiple BWPs, each spanning a contiguous set of frequency resources, e.g., a set of PRBs. A BWP may be activated for the UE from the set of configured BWPs. The UE may not be expected to receive PDSCH, PDCCH, CSI-RS, TRS, etc., outside of an active DL BWP. The UE may not transmit PUSCH or PUCCH outside of an active UL BWP. The UE may receive an indication from a network to switch from a first active BWP to a second active BWP from the set of configured BWPs. In some aspects, the UE may switch from the active DL BWP to a default DL BWP based on a period of inactivity. The default DL BWP may provide power savings for the UE, and the UE may switch to the default DL BWP in response to the expiration of an inactivity timer in order to save power. FIG. 6 is a diagram 600 illustrating an example BWP switching in accordance with various aspects of the present disclosure. Diagram 600 is illustrated with respect to slots in which a smaller/narrower DL BWP or a larger/wider DL BWP may be configured, where the narrower DL BWP may be configured as a default DL BWP for power savings.

As shown in diagram 600, control channel (CCH) information may indicate whether the next slot has a grant. For example, with the narrow DL BWP configured, slot n includes a CCH with no grant, and accordingly, there is no data in slot n+1, e.g., which may be conducive to microsleep. The CCH in slot n+1, however, includes a grant for slot n+2 in the narrow DL BWP (ID=1) for a small amount of data that can be received by a UE in a single slot having the narrow DL BWP. Accordingly, slot n+2 includes the grant and the small amount of data, and no BWP switch is performed.

When operating in an active DL BWP of a source cell, a UE may be provided with a default DL BWP and a timer value, e.g., by “bwp-inactivityTimer.” The UE may be configured to decrement the timer (e.g., at the end of a subframe for FR1, or at the end of a half subframe for FR2), and if the UE does not receive DCI indicating a DL assignment/UL grant, or a MAC PDU for unicast/multicast broadcast signal (MBS) in a configured DL assignment on the active BWP (e.g., during the interval of the subframe for FR1 or of the half subframe for FR2).

At slot m+1, a large amount of data arrives in a queue, and the corresponding CCH indicates a DL grant for large data, which will cause a BWP switch to wide BWP ID=2, for the next slot: m+2. At slot m+2, the large data is received by the UE via the wide BWP (while not drawn to scale, FIG. 6 illustrates that the large data may not be carried within the narrow BWP, hence the switch. At a later slot x, it may be assumed that no new data has been received via the wide BWP, and that a timer has expired, such that the UE is configured to switch from the wider, active DL BWP (ID=2) to the narrower, default DL BWP (ID=1) for power and signaling efficiencies. That is, the UE may be configured to switch to the default DL BWP of the source cell (e.g., a narrower BWP) when the BWP timer expires after some period of scheduling inactivity. If the UE receives a DL grant, the UE may switch to the wider, active DL BWP to receive the DL data according to the DL grant. The UE may remain on the active DL BWP until the inactivity timer expires, again, at which time the UE may switch back to the narrower default DL BWP.

Time gaps may be provided at the end of the slots to accommodate uplink control blocks (ULCBs) for TDD are not illustrated for clarity and brevity.

As discussed above, if the UE switches to the default DL BWP based on inactivity and during a time after the UE sends the measurement report, such as shown at 415 in FIG. 4, the UE may miss the HO/beam switch command that results from the measurement report. The UE may miss the opportunity for the network-initiated mobility. If the link quality does not improve in the default DL BWP, the UE may attempt RRC re-establishment or the initiation of cell selection/re-selection after releasing an RRC connection with the source node as part of an RRC re-establishment failure. PRACH resources may not be configured in a UL BWP associated with the default DL BWP or the active DL BWP, and the UE may switch BWPs in order to perform the RACH.

A UE may measure one or more beams from a UE to derive the beam quality or cell quality. In the RRC-connected mode, a UE may measure one or more beams of a cell and the measurements results (e.g., the power values) may be averaged to derive the cell quality. In some aspects, the UE may be configured to consider a subset of the detected beams.

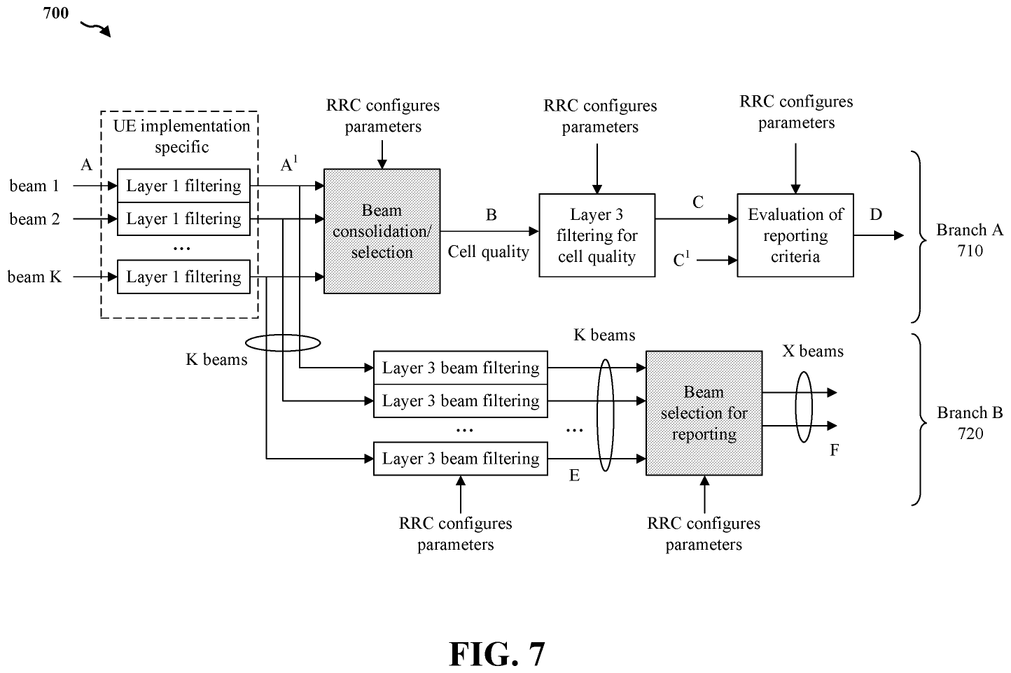

FIG. 7 is a diagram 700 illustrating an example measurement model. As shown in FIG. 7, the measurements that may be performed by a UE may include L1 measurements (filtering) and L3 measurements (filtering). The L1 measurements may be, for example, the measurements for the reference signal received power (RSRP), and may be UE implementation specific. The L3 measurements may be based on the L1 measurements and are made on a longer interval than the L1 measurements. Hence, the L3 measurements may provide a more stable and longer-term metric of the beams than the L1 measurements and therefore are more suitable for applications that require long term measurements, such as handover or beam level mobility. The measurement (filtering) may take place at the physical layer to derive beam quality, and then at the RRC level, to derive cell quality from multiple beams. For example, as shown in FIG. 7, the branch A 710 of the measurement flow, the L3 measurement (filtering) is performed for cell level quality (i.e., based on the aggregation of multiple beams), and the measurement result may be useful in cell level mobility, such as the handover. In the branch B 720 of the measurement flow, the L3 measurements (filtering) are beam-specific (i.e., performed on individual beams), and the measurement results may be useful for the beam level mobility. The cell quality from the beam measurements may be derived in the same way for the serving cell(s) and the non-serving cell(s), and the UE may be configured to report the X best beams in the measurement reports.

The CHO and CPC may improve the robustness and reliability of HO and secondary cell group (SCG) change in DC, as the target cell configurations for CHO/CPC may include multiple candidates selected by the source node and the CHO/CPC condition evaluation and execution may be performed by the UE. However, early data forwarding and resource assignment (RA) resource reservation may need to be enabled on multiple cells before CHO/CPC execution, which may increase the system/signaling overhead and reduce the spectral/energy efficiency of the network. Additionally, for the network-initialed HO and CHO/CPC, it takes time for a UE to receive an RRC message (e.g., the RRCReconfiguration message) after sending the measurement reports. Hence, the BWP switching due to the expiration of BWP inactivity timer in the source node may aggravate the latency and power issues of the HO.

The present disclosure provides methods and apparatus that provide a configuration for the mobility timer and signaling enhancement of the network to assist with the UE's measurement and mobility. The disclosed methods and apparatus may mitigate the potential increase of latency/overhead/power incurred by undesirable BWP switching during HO (including network-initiated HO, CHO, CPC, etc.).

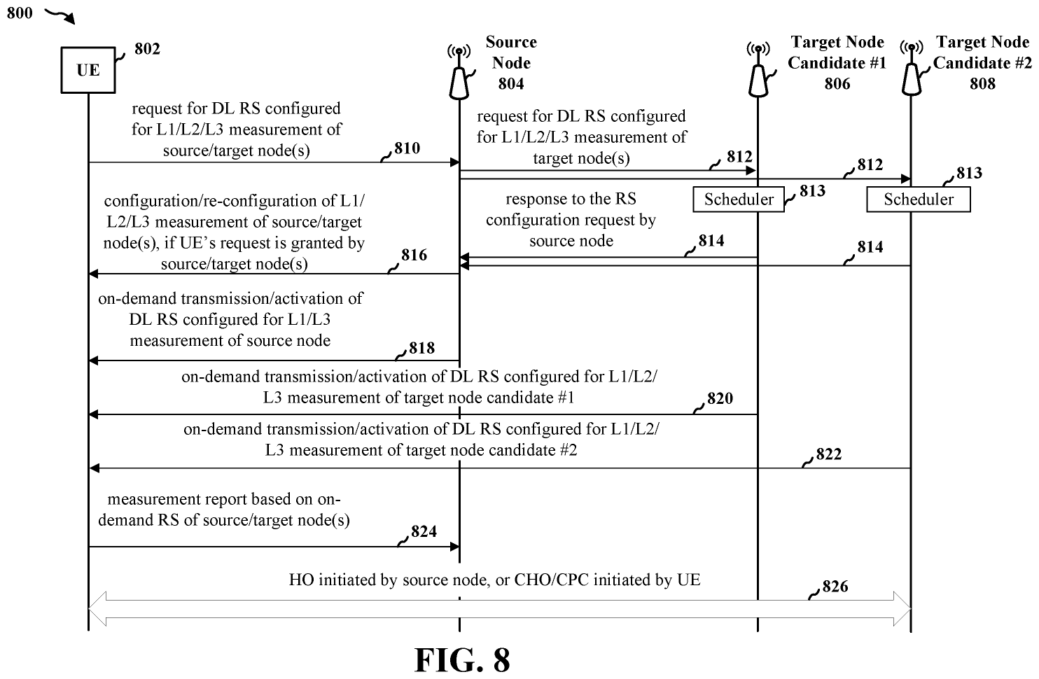

One aspect of the present disclosure is directed to network assistance for on-demand reference signal (RS) transmission/activation. FIG. 8 is a call flow diagram 800 illustrating the network assistance for on-demand RS transmission/activation in accordance with various aspects of the present disclosure. As shown in FIG. 8, in addition to the measurement resource sets configured for the UE 802 by dedicated RRC, the network may additionally support on-demand transmission/activation of aperiodic/periodic DL RS configured for L1/L2/L3 measurements of source node(s) and target node(s). Examples of DL RS applicable to on-demand transmission/activation may include, but not limited to: a non-cell defining synchronization signal block (NCD-SSB), a positioning reference signal (PRS), a channel state information reference signal (CSI-RS), or a tracking reference signal (TRS). The UE's request may be sent to the source node via a UL RS/sequence (e.g., PRACH, SRS) or UL control/data channels (PUCCH, PUSCH). The network's responses (from the source node and target node(s)) may be delivered to the UE by the source node, using DCI, RRC, medium access control-control element (MAC-CE), or a combination thereof.

For example, as shown in FIG. 8, the UE 802 may send a request for DL RS configured for L1/L2/L3 measurement of source/target node(s) to the source node at 810. Upon receiving the request, the source node 804 may forward, at 812, the request for DL RS configured for L1/L2/L3 measurement of target node(s) to one or more target nodes (e.g., the target node candidate #1 806 and the target node candidate #2808). Upon receiving the request from the source node 804, each of the one or more target nodes may perform a scheduling process, at 813, to check its capability for, for example, admitting the UE or transmitting the requested RS. The target nodes will send, at 814, to the source node 804 the response to the RS configuration, which may include the target node's decision to admit the UE or to transmit the requested RS. Upon receiving the response from the target nodes, the source node 804 may send, at 816, the configuration/reconfiguration of L1/L2/L3 measurement of source/target node(s) if UE's request is granted by the source/target node(s). The source node 806 and the one or more target nodes (e.g., the target node candidate #1 806 and the target node candidate #2 808) may each send, at, for example, 818, 820, 822, respectively, the on-demand transmission/activation of DL RS configured for L1/L2/L3 measurement to the UE 802. In some aspects, the on-demand transmission/activation of DL RS may be used by multiple UEs belonging to the same UE group and are connected to the same source node (e.g., multiple UEs connected to the source node 804). The UE 802 may transmit, at 824, the measurement report based on the on-demand RS of source/target node(s) to the source node 804. Based on the measurement report, at 826, the source node 804 may initiate a HO, or the UE 802 may initiate a CHO/CPC.

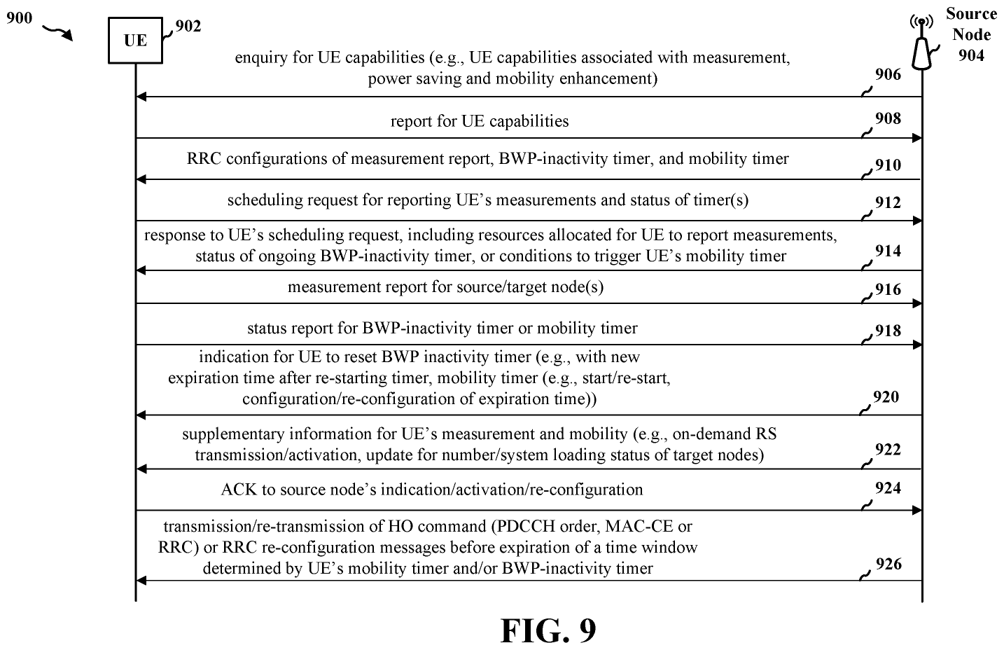

Another aspect of the present disclosure is directed to a network-assisted timer adaptation for BWP switching and mobility. FIG. 9 is a call flow diagram 900 illustrating the network-assisted timer adaptation for BWP switching and mobility in accordance with various aspects of the present disclosure. As shown in FIG. 9, the source node 904 may send, at 906, an inquiry for UE capabilities to the UE 902. The UE's capability may include the capabilities associated with measurement, power saving and mobility enhancement, and the UE 902 may report, at 908, the UE capabilities to the source node 904. The source node 904 may further transmit, at 910. RRC configurations of measurement report (MR), BWP-inactivity timer, and mobility timer to the UE 902. At 912, the UE 902 may send a scheduling request for reporting UE's measurements and the status of timer(s) to the source node 904. At 914, the source node 904 may send to the UE 902 a response to UE's scheduling request. The response may include resources allocated for UE 902 to report measurements, the status of ongoing BWP-inactivity timer, or conditions to trigger UE's mobility timer. At 916, the UE 902 may transmit to the source node 904 the measurement report for source/target node(s). At 918, the UE 902 may transmit to the source node 904 the status report for BWP-inactivity timer or mobility timer. The measurement report for source/target node(s) and the status report for the BWP-inactivity timer or mobility timer may be multiplexed on a single UL channel or separately transmitted on multiple UL channels. Upon receiving the UE's measurement report and the status report, the source node 904 may, at 920, transmit an indication for UE 902 to reset the BWP inactivity timer. For example, the source node 904 may provide a new expiration time after re-starting timer, or provide a new configuration for the mobility timer (e.g., start/re-start, configuration/reconfiguration of expiration time). At 922, the source node 904 may further transmit supplementary information for UE's measurement and mobility to the UE 902. For example, the source node 904 may provide on-demand RS transmission/activation, update for number/system loading status of target nodes to the UE 902. At 924, the UE 902 may transmit to the source node 804 an acknowledgement (ACK) to the source node's indication/activation/reconfiguration. At 926, based on the ACK from the UE 902, the source node 904 may send the transmission/re-transmission of HO command (PDCCH order, MAC-CE or RRC) or RRC reconfiguration messages before the expiration of a time window determined by UE's mobility timer and/or BWP-inactivity timer.

Another aspect of the present disclosure is directed to the duplication of mobility signaling by the network. In the duplication of mobility signaling, based on a UE's reporting for measurements and timer status, the network may respond with an indication transmitted by, for example, DCI, RRC, MAC-CE or sequence/RS, which may signal that the HO command or RRC reconfiguration messages will be duplicated. In some aspects, the duplication may happen in multiple BWPs of the source node. For example, the source node may transmit the HO command or RRC reconfigurations in both active BWP and default BWP of the UE (or a UE group, if group HO/CHO/CPC applies) of the source node. In some aspects, the duplication may happen across multiple nodes within a time window, and the time window may start from a reference time associated with the UE's reception of the network's indication. For example, the source node and the target node may jointly transmit the HO command or RRC reconfigurations of a UE (or a UE group, if group HO/CHO/CPC applies) in a single frequency network (SFN) scheme. In some aspects, the mobility signaling may be multicast to a group of UE connected to the source node.

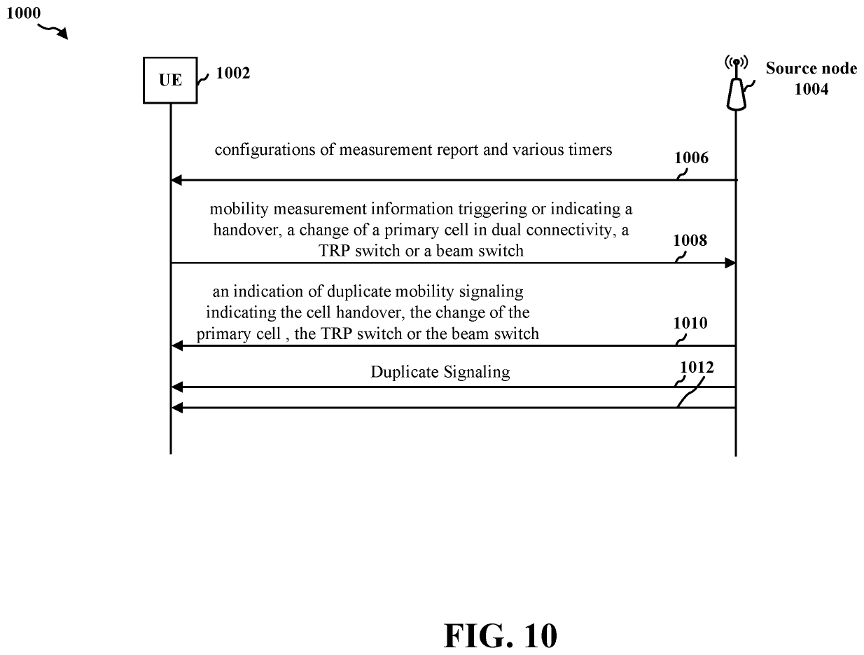

FIG. 10 is a call flow diagram 1000 illustrating the duplication of mobility signaling by the network in accordance with various aspects of this present disclosure. As shown in FIG. 10, at 1006, the source node 1004 may, for example, via RRC configuration, transmit to the UE 1002 configurations for measurement report and various timers. The various timers may include, for example, the BWP-inactivity timer or the mobility timer. At 1008, the source node 1004 may receive the mobility measurement information from the UE 1002. The mobility measurement information may indicate a handover or a beam switch. At 1010, the source node 1006 may provide an indication of duplicate mobility signaling triggering or indicating the cell handover, the change of primary cell in dual connectivity, the TRP switch, or the beam switch. At 1012, the source node may provide the duplicate signaling.

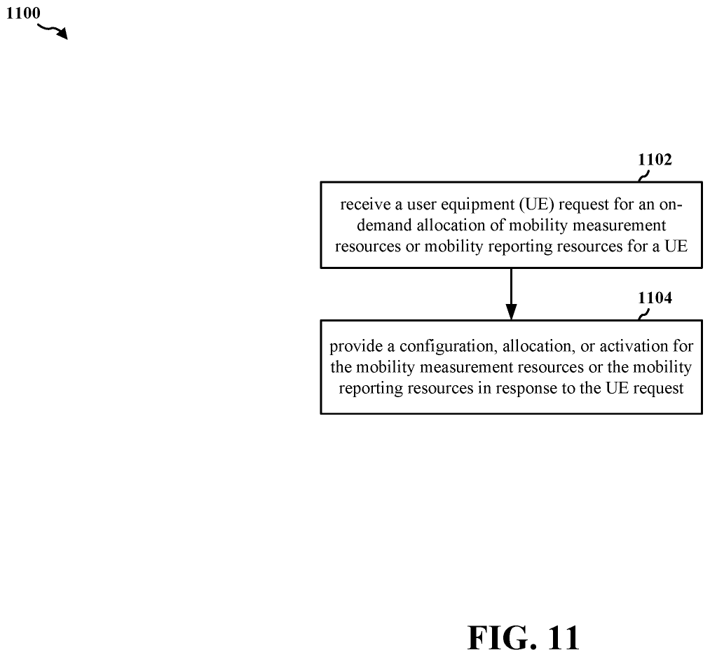

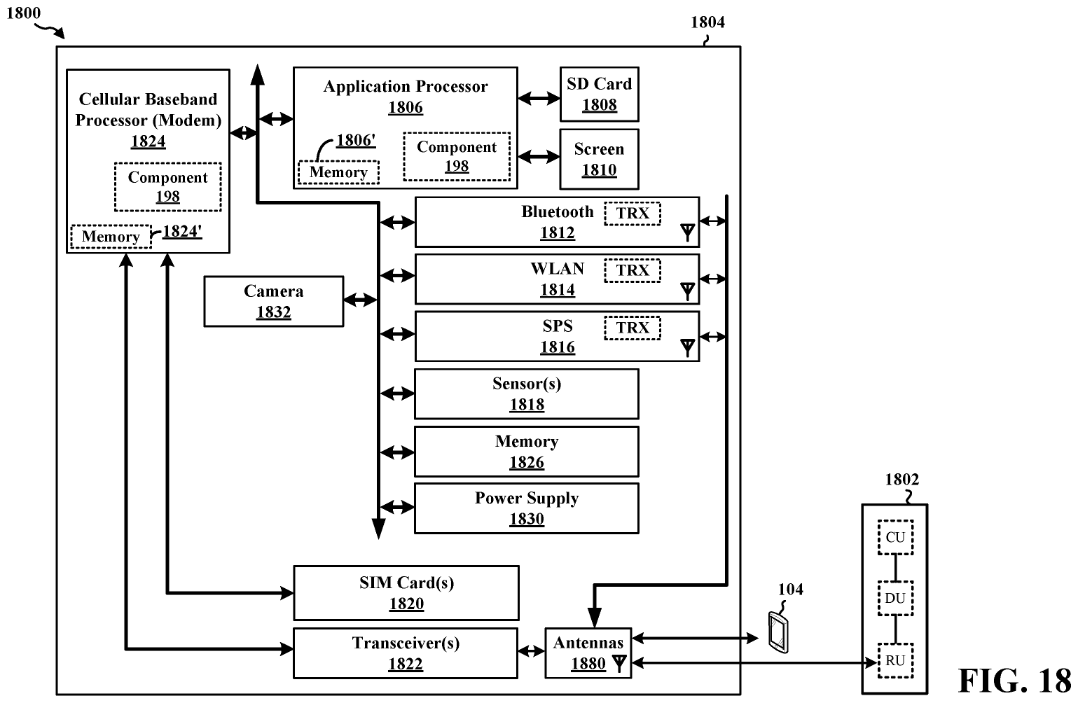

FIG. 11 is a flowchart 1100 illustrating methods of wireless communication at a source node in accordance with various aspects of the present disclosure. The method may be performed by the source node in the context of a target node, in various aspects. The source node may be a source base station, and the target node may be a target base station, in some aspects. In other aspects, the source node may be a source TRP, and the target node may be a target TRP. The source TRP and target TRP may be for the same base station or may be for different base stations. In some aspects, the source node may be a first component of a base station, and the target node may be a second component of the same base station or of a different base station. The base station may be the base station, or a component of the base station, in the access network of FIG. 1 or a core network component (e.g., base station 102, 310; or the network entity 1802 in the hardware implementation of FIG. 18). The method improves the flexibility and reliability in handling a UE's request for mobility measurement sources or mobility reporting resources. Thus, it improves the efficiency of wireless communication.

As shown in FIG. 11, at 1102, the source node may receive a UE request for an on-demand allocation of mobility measurement resources or mobility reporting resources for a UE. The source node may receive the UE request from a UE. The UE may be the UE 104, 350, 802, 902, 1002, or the apparatus 1804 in the hardware implementation of FIG. 18. FIGS. 8, 9, and 10 illustrate various aspects of the steps in connection with flowchart 1100. For example, referring to FIG. 8, the source node 804 may receive, at 810, a UE request for an on-demand allocation of mobility measurement resources or mobility reporting resources (e.g., the request for DL RS configured for L1/L2/L3 measurement) for a UE 802. In some aspects, the on-demand allocation of mobility measurement resources or mobility reporting resources may be used by multiple UEs belonging to the same UE group and connected to the same source node (e.g., multiple UE connected to the source node 804). In some aspects, 1102 may be performed by the mobility enhancement component 199.

At 1104, the source node may provide a configuration, allocation, or activation for the mobility measurement resources or the mobility reporting resources in response to the UE request. For example, referring to FIG. 8, the source node 804 may, at 816, provide a configuration, allocation, or activation for the mobility measurement resources or the mobility reporting resources (e.g., configuration/reconfiguration of L1/L2/L3 measurement of source/target node(s)) in response to the UE request. In some aspects, 1104 may be performed by the mobility enhancement component 199.

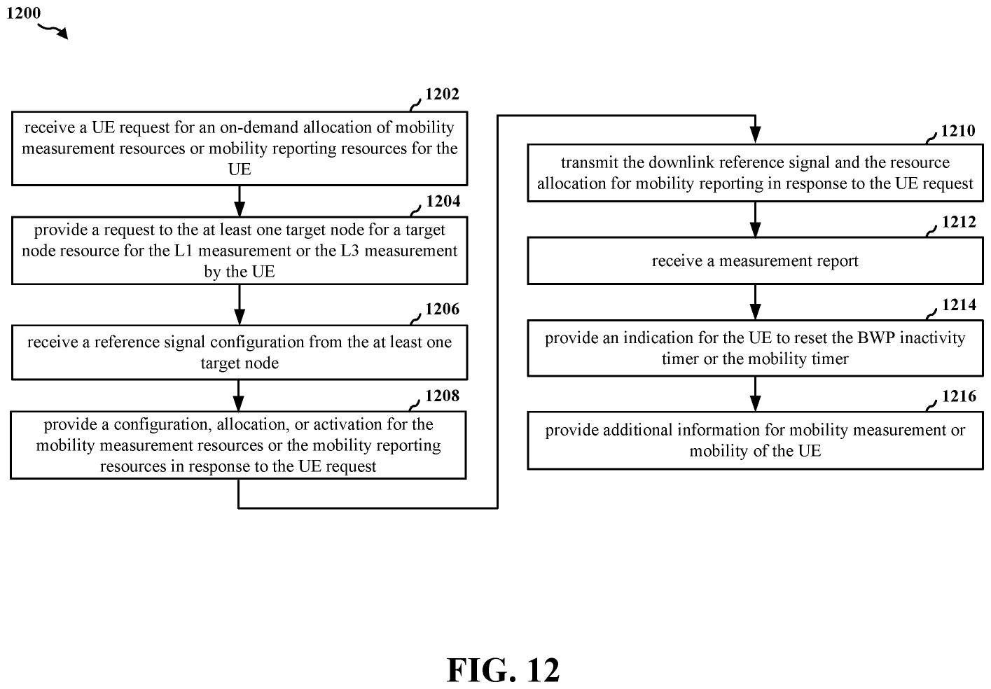

FIG. 12 is a flowchart 1200 illustrating methods of wireless communication at a source node in accordance with various aspects of the present disclosure. The method may be performed by the source node in the context of a target node, in various aspects. The source node may be a source base station, and the target node may be a target base station, in some aspects. In other aspects, the source node may be a source TRP, and the target node may be a target TRP. The source TRP and target TRP may be for the same base station or may be for different base stations. In some aspects, the source node may be a first component of a base station, and the target node may be a second component of the same base station or of a different base station. The base station may be the base station, or a component of the base station, in the access network of FIG. 1 or a core network component (e.g., base station 102, 310; or the network entity 1802 in the hardware implementation of FIG. 18). The method improves the flexibility and reliability in handling a UE's request for mobility measurement sources or mobility reporting resources. Thus, it improves the efficiency of wireless communication.

As shown in FIG. 12, at 1202, the source node may receive a UE request for an on-demand allocation of mobility measurement resources or mobility reporting resources for a UE. The source node may receive the UE request from a UE. The UE may be the UE 104, 350, 802, 902, 1002, or the apparatus 1804 in the hardware implementation of FIG. 18. FIGS. 8, 9, and 10 illustrate various aspects of the steps in connection with flowchart 1200. For example, referring to FIG. 8, the source node 804 may receive, at 810, a UE request for an on-demand allocation of mobility measurement resources or mobility reporting resources (e.g., the request for DL RS configured for L1/L2/L3 measurement) for a UE 802. In some aspects, the on-demand allocation of mobility measurement resources or mobility reporting resources may be used by multiple UEs belonging to the same UE group and connected to the same source node (e.g., multiple UE connected to the source node 804). In some aspects, 1202 may be performed by the mobility enhancement component 199.

At 1208, the source node may provide a configuration, allocation, or activation for the mobility measurement resources or the mobility reporting resources in response to the UE request. For example, referring to FIG. 8, the source node 804 may, at 816, provide a configuration, allocation, or activation for the mobility measurement resources or the mobility reporting resources (e.g., configuration/reconfiguration of L1/L2/L3 measurement of source/target node(s)) in response to the UE request. In some aspects, 1208 may be performed by the mobility enhancement component 199.

In some aspects, the request may be for a downlink reference signal for L1 measurement, L2 measurement, or L3 measurement of the source node and at least one target node. For example, referring to FIG. 8, the request may be for a DL RS for L1 measurement, L2 measurement, or L3 measurement of the source node 804 and at least one target node (806, 808).

In some aspects, the source node may, at 1210, transmit the downlink reference signal in response to the UE request and, at 1212, receive a measurement report after measuring the downlink reference signal and using at least a part of the resources allocated for mobility reporting in response to the UE request. The measurement report may include measurement information for one or more of the source node or the at least one target node. For example, referring to FIG. 8, the source node 804 may transmit, at 818, the DL RS in response to the UE request and receive, at 824, a measurement report (the measurement report based on the on-demand RS of source/target node(s)) after measuring the downlink reference signal and using at least a part of the resources allocated for mobility reporting in response to the UE request. In some aspects, 1210 and 1212 may be performed by the mobility enhancement component 199.

In some aspects, the downlink reference signal may be aperiodic or periodic. The downlink reference signal may include at least one of: an NCD-SSB, a PRS, a CSI-RS, or a TRS. For example, referring to FIG. 8, when the source node 804 transmits, at 818, the DL RS to the UE 802, the DL RS may be aperiodic or periodic, and may include at least one of: an NCD-SSB, a PRS, a CSI-RS, or a TRS.

In some aspects, the UE request may be indicated in at least one of: an uplink reference signal, an uplink sequence, an uplink control channel, or an uplink data channel. For example, referring to FIG. 8, when the UE 802 sends, at 810, the request for DL RS to the source node 804, the request may be indicated in at least one of: an uplink reference signal, an uplink sequence, an uplink control channel, or an uplink data channel.

In some aspects, the configuration, the allocation, or the activation in response to the UE request may be included in DCI, an RRC message, a MAC-CE, or a combination thereof. For example, referring to FIG. 8, when the source node 804 transmits, at 816, the configuration/reconfiguration of L1/L2/L3 measurement, the configuration/reconfiguration may be included in DCI, an RRC message, a MAC-CE, or a combination thereof.

In some aspects, the source node may configure one or more configurations for the L1 measurement, the L2 measurement, or the L3 measurement. The source node may activate one of the one or more configurations in response to the UE request. For example, referring to FIG. 8, the source node 804 may configure, at 816, one or more configurations for the L1 measurement, the L2 measurement, or the L3 measurement. The source node 804 may activate, at 816, one of the one or more configurations in response to the UE request the source node 804 receives at 810.

In some aspects, the source node may, at 1204, provide a request to the at least one target node for a target node resource for the L1 measurement, the L2 measurement, or the L3 measurement by the UE. The source node may, at 1206, further receive a reference signal configuration from the at least one target node. The source node may provide the configuration in response to the UE request, and the configuration may include the reference signal configuration from the at least one target node. For example, referring to FIG. 8, the source node 804 may provide, at 812, a request to the at least one target node (806, 808) for a target node resource for the L1 measurement, the L2 measurement, or the L3 measurement by the UE 802. The source node 804 may further receive, at 814, a reference signal configuration from the at least one target node (806, 808). The source node 804 may provide, at 816, the configuration in response to the UE request (received at 810), and the configuration may include the reference signal configuration from the at least one target node (806, 808). In some aspects, 1204 and 1206 may be performed by the mobility enhancement component 199.

In some aspects, the UE request may be for the mobility reporting resources to report one or more of: a mobility measurement report, a status of a BWP inactivity timer, a status of a mobility timer, or a condition to trigger or reset a mobility timer or a BWP inactivity timer, and the source node may receive at least one of the mobility measurement report, the status of the BWP inactivity timer, the status of the mobility timer, or the condition to trigger or reset the mobility timer or the BWP inactivity timer. For example, referring to FIG. 8, the UE request (the source node 804 received at 810) may be for the mobility reporting resources to report one or more of: a mobility measurement report, a status of a BWP inactivity timer, a status of the mobility timer, or a condition to trigger or reset the mobility timer or the BWP inactivity timer. The source node 804 may receive at least one of the mobility measurement report, the status of the BWP inactivity timer, the status of the mobility timer, or the condition to trigger or reset the mobility timer or the BWP inactivity timer (e.g., the measurement report received at 824). Referring to FIG. 9, the source node 904 may receive at least one of the mobility measurement report (the measurement report at 916), the status of the BWP inactivity timer (status report for the BWP-inactivity timer or mobility timer at 918), the status of the mobility timer, or the condition to trigger or reset the mobility timer or the BWP inactivity timer.

In some aspects, the source node may, at 1214, provide an indication for the UE to reset the BWP inactivity timer or the mobility timer. For example, referring to FIG. 9, the source node 904 may provide, at 920, an indication for the UE to reset the BWP inactivity timer or the mobility timer. In some aspects, 1214 may be performed by the mobility enhancement component 199.

In some aspects, the source node may, at 1216, provide additional information for mobility measurement or mobility of the UE. The additional information may include at least one of an on-demand reference signal transmission or on-demand reference signal activation, or update information for the at least one target node. For example, referring to FIG. 9, the source node 904 may provide, at 922, additional information for mobility measurement or mobility of the UE (the supplementary information for UE's measurement and mobility). The additional information may include at least one of an on-demand reference signal transmission or on-demand reference signal activation, or update information for the at least one target node. In some aspects, 1216 may be performed by the mobility enhancement component 199.

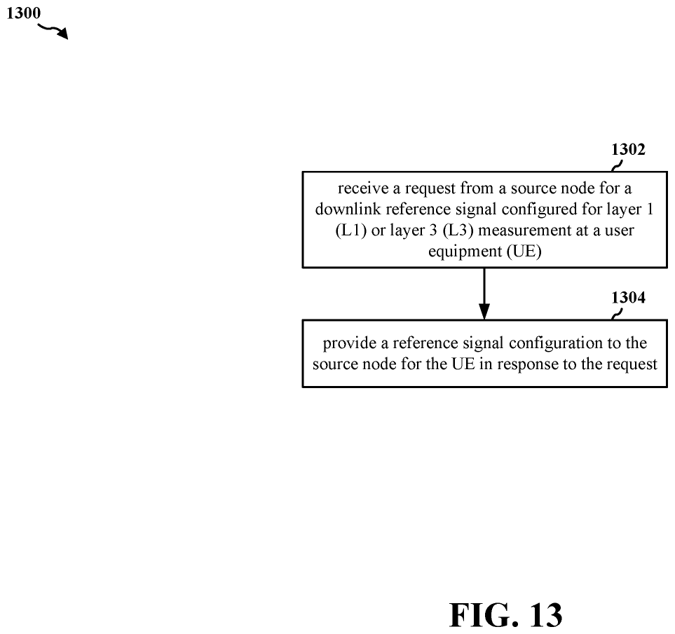

FIG. 13 is a flowchart 1300 illustrating methods of wireless communication at a target node in accordance with various aspects of the present disclosure. The method may be performed by the target node in the context of a source node, in various aspects. The source node may be a source base station, and the target node may be a target base station, in some aspects. In other aspects, the source node may be a source TRP, and the target node may be a target TRP. The source TRP and target TRP may be for the same base station or may be for different base stations. In some aspects, the source node may be a first component of a base station, and the target node may be a second component of the same base station or of a different base station. The base station may be the base station, or a component of the base station, in the access network of FIG. 1 or a core network component (e.g., base station 102, 310; or the network entity 1802 in the hardware implementation of FIG. 18). The method improves the flexibility and reliability in handling a UE's request for mobility measurement sources or mobility reporting resources. Thus, it improves the efficiency of wireless communication.

As shown in FIG. 13, at 1302, the target node may receive a request from the source node for a downlink reference signal configured for L1 or L3 measurement at a UE. The UE may be the UE 104, 350, 802, 902, 1002, or the apparatus 1804 in the hardware implementation of FIG. 18. FIGS. 8, 9, and 10 illustrate various aspects of the steps in connection with flowchart 1300. For example, referring to FIG. 8, the target node 806 may receive, at 812, a request from the source node 804 for a DL RS configured for L1 or L3 measurement at a UE 802. In some aspects, 1302 may be performed by the mobility enhancement component 199.

At 1304, the target node may provide a reference signal configuration to the source node for the UE in response to the request. For example, referring to FIG. 8, the target node 806 may provide, at 814, an RS configuration to the source node 804 for the UE 802 in response to the request (received at 812). In some aspects, 1304 may be performed by the mobility enhancement component 199.

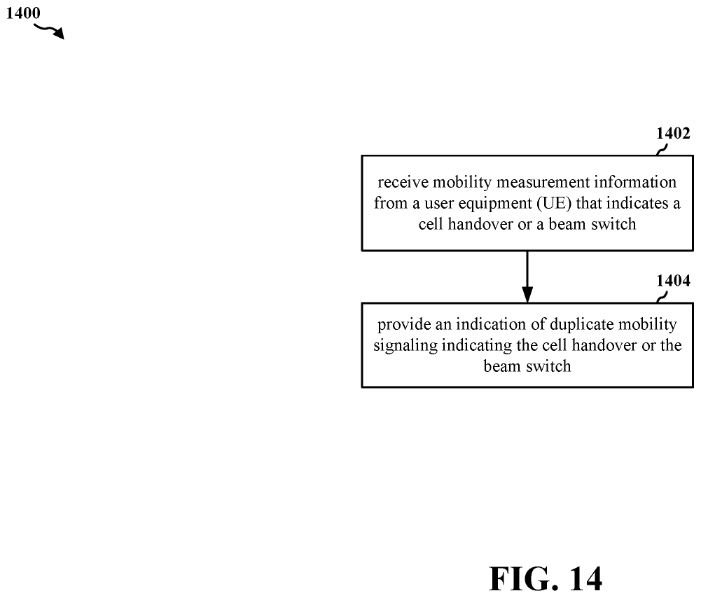

FIG. 14 is a flowchart 1400 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102. 310; source node 804, 904, 1004; or the network entity 1802 in the hardware implementation of FIG. 18). The method improves the flexibility and reliability in handling a UE's request for mobility measurement sources or mobility reporting resources. Thus, it improves the efficiency of wireless communication.

As shown in FIG. 14, at 1402, the network entity may receive mobility measurement information from a UE that indicates a cell handover, a change of primary cell in dual connectivity, a TRP switch, or a beam switch. The UE may be the UE 104, 350, 802, 902, 1002, or the apparatus 1804 in the hardware implementation of FIG. 18. FIGS. 8. 9, and 10 illustrate various aspects of the steps in connection with flowchart 1400. For example, referring to FIG. 10, the network entity (source node 904) may receive, at 908, mobility measurement information from a UE 902 that triggers or indicates a cell handover, a change of primary cell in dual connectivity, a TRP switch, or a beam switch. In some aspects, 1402 may be performed by the mobility enhancement component 199.

At 1404, the network entity may provide an indication of duplicate mobility signaling triggering or indicating the cell handover, the change of primary cell in dual connectivity, the TRP switch, or the beam switch. For example, referring to FIG. 10. the network entity (source node 904) may provide, at 910, an indication of duplicate mobility signaling triggering or indicating the cell handover, the change of primary cell in dual connectivity, the TRP switch, or the beam switch. In some aspects, 1404 may be performed by the mobility enhancement component 199.

In some aspects, the indication of the duplicate mobility signaling may be provided based on a measurement from the UE or a timer status of the UE. For example, referring to FIG. 10, when the source node 1004 transmits, at 1010, the indication of the duplication mobility signaling to the UE 1002, the indication may be provided based on a measurement from the UE 1002 or a timer status of the UE 1002. In some aspects, the indication of the duplicate mobility signaling may be included in at least one of: DCI, an RRC message, a MAC-CE, a sequence, or a reference signal. For example, referring to FIG. 10, when the source node 1004 transmits, at 1010, the indication of the duplication mobility signaling to the UE 1002, the indication of the duplicate mobility signaling may be included in at least one of: DCI, an RRC message, a MAC-CE, a sequence, or a reference signal.

In some aspects, the duplicate mobility signaling may include a command for the cell handover, the change of the primary cell in dual connectivity, the TRP switch, or the beam switch duplicated in multiple BWPs during a window of time. The window may start from a reference time associated with UE's reception of the mobility signaling. For example, referring to FIG. 10, when the source node 1004 transmits, at 1010, the indication of the duplication mobility signaling to the UE 1002, the duplicate mobility signaling may include a command for the cell handover, the change of the primary cell, the TRP switch, or the beam switch duplicated in multiple BWPs during a window of time. The window may start from a reference time associated with UE 1002's reception of the mobility signaling.

In some aspects, the multiple BWPs may include an active downlink BWP and a default downlink BWP of a source node. For example, the multiple BWPs may include an active downlink BWP and a default downlink BWP of the source node 1004.

In some aspects, the duplicate mobility signaling may include joint transmission from a source node and a target node in an SFN transmission scheme. For example, referring to FIG. 10, when the source node 1004 transmits, at 1010, the indication of the duplication mobility signaling to the UE 1002, the duplicate mobility signaling may include joint transmission from the source node 1004 and a target node in an SFN transmission scheme.

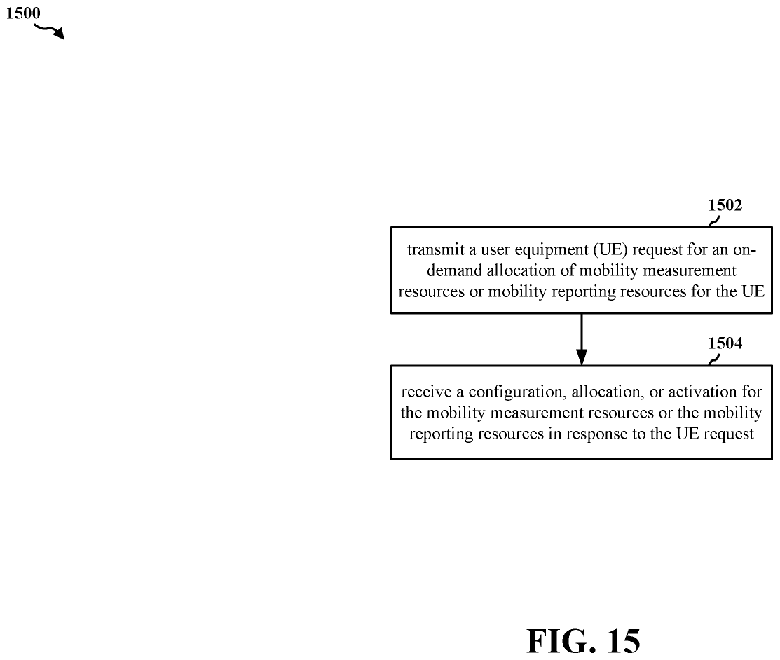

FIG. 15 is a flowchart 1500 illustrating methods of wireless communication at a UE in accordance with various aspects of the present disclosure. The method may be performed by a UE in the context of a target node and a source node, in various aspects. The UE may be the UE 104, 350, 802, 902, 1002, or the apparatus 1804 in the hardware implementation of FIG. 18. The source node may be a source base station, and the target node may be a target base station, in some aspects. In other aspects, the source node may be a source TRP, and the target node may be a target TRP. The source TRP and target TRP may be for the same base station or may be for different base stations. In some aspects, the source node may be a first component of a base station, and the target node may be a second component of the same base station or of a different base station. The base station may be the base station, or a component of the base station, in the access network of FIG. 1 or a core network component (e.g., base station 102, 310; or the network entity 1802 in the hardware implementation of FIG. 18). The method improves the flexibility and reliability in handling a UE's request for mobility measurement sources or mobility reporting resources. Thus, it improves the efficiency of wireless communication.

As shown in FIG. 15, at 1502, the UE may transmit a UE request for an on-demand allocation of mobility measurement resources or mobility reporting resources for the UE. The UE may transmit the UE request to a source node. The source node may be a base station, or a component of a base station, in the access network of FIG. 1 or a core network component (e.g., base station 102, 310; source node 804, 904, 1004; or the network entity 1802 in the hardware implementation of FIG. 18). FIGS. 8, 9, and 10 illustrate various aspects of the steps in connection with flowchart 1500. For example, referring to FIG. 8, the UE 802 may transmit, at 810, a UE request for an on-demand allocation of mobility measurement resources or mobility reporting resources for the UE (e.g., the request for DL RS configured for L1/L2/L3 measurement of source/target node(s)). In some aspects, 1502 may be performed by the mobility enhancement component 198.

At 1504, the UE may receive a configuration, allocation, or activation for the mobility measurement resources or the mobility reporting resources in response to the UE request. For example, referring to FIG. 8, the UE 802 may receive, at 816, a configuration, allocation, or activation for the mobility measurement resources or the mobility reporting resources (e.g., the configuration/reconfiguration of L1/L2/L3 measurement of source/target node(s)) in response to the UE request (the UE sends at 810). In some aspects, 1504 may be performed by the mobility enhancement component 198.

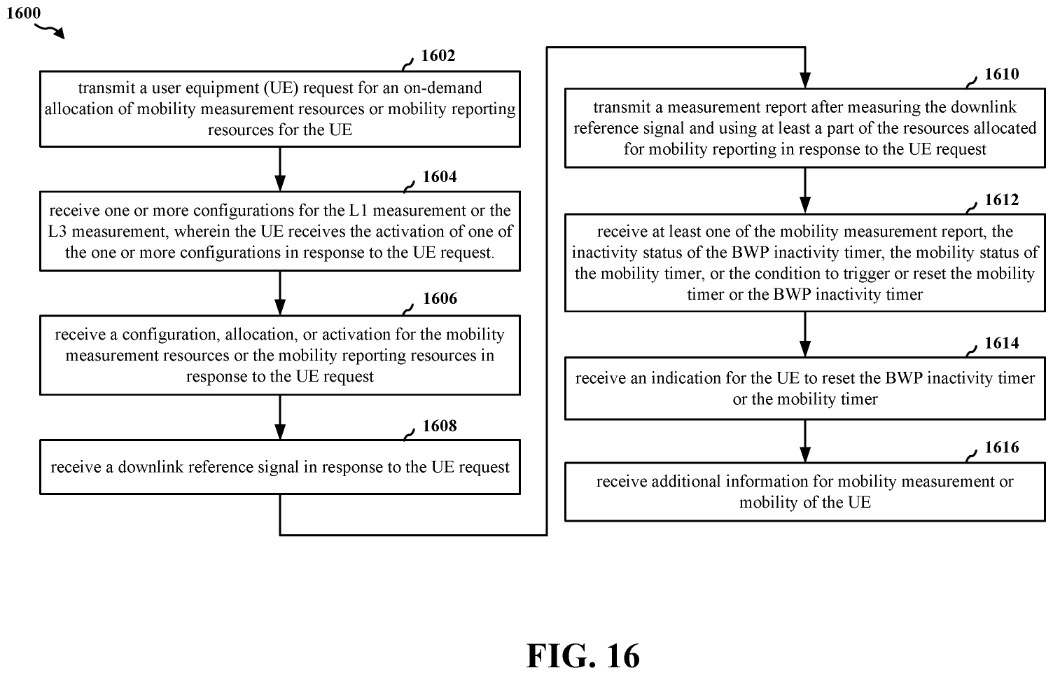

FIG. 16 is a flowchart 1600 illustrating methods of wireless communication at a UE in accordance with various aspects of the present disclosure. The method may be performed by a UE in the context of a target node and a source node, in various aspects. The UE may be the UE 104, 350, 802, 902, 1002, or the apparatus 1804 in the hardware implementation of FIG. 18. The source node may be a source base station, and the target node may be a target base station, in some aspects. In other aspects, the source node may be a source TRP, and the target node may be a target TRP. The source TRP and target TRP may be for the same base station or may be for different base stations. In some aspects, the source node may be a first component of a base station, and the target node may be a second component of the same base station or of a different base station. The base station may be the base station, or a component of the base station, in the access network of FIG. 1 or a core network component (e.g., base station 102, 310; or the network entity 1802 in the hardware implementation of FIG. 18). The method improves the flexibility and reliability in handling a UE's request for mobility measurement sources or mobility reporting resources. Thus, it improves the efficiency of wireless communication.

As shown in FIG. 16, at 1602, the UE may transmit a UE request for an on-demand allocation of mobility measurement resources or mobility reporting resources for the UE. The UE may transmit the UE request to a source node. The source node may be a base station, or a component of a base station, in the access network of FIG. 1 or a core network component (e.g., base station 102, 310; source node 804, 904, 1004; or the network entity 1802 in the hardware implementation of FIG. 18). FIGS. 8, 9, and 10 illustrate various aspects of the steps in connection with flowchart 1500. For example, referring to FIG. 8, the UE 802 may transmit, at 810, a UE request for an on-demand allocation of mobility measurement resources or mobility reporting resources for the UE (e.g., the request for DL RS configured for L1/L2/L3 measurement of source/target node(s)). In some aspects, 1602 may be performed by the mobility enhancement component 198.

At 1606, the UE may receive a configuration, allocation, or activation for the mobility measurement resources or the mobility reporting resources in response to the UE request. For example, referring to FIG. 8, the UE 802 may receive, at 816, a configuration, allocation, or activation for the mobility measurement resources or the mobility reporting resources (e.g., the configuration/reconfiguration of L1/L2/L3 measurement of source/target node(s)) in response to the UE request (the UE sends at 810). In some aspects, 1606 may be performed by the mobility enhancement component 198.

In some aspects, the request may be for a downlink reference signal for L1 measurement, L2 measurement, or L3 measurement of a source node and at least one target node. For example, referring to FIG. 8, the request may be for a DL RS for L1 measurement, L2 measurement, or L3 measurement of a source node 804 and at least one target node (806, 808).

In some aspects, the UE may be further configured to receive, at 1608, the downlink reference signal in response to the UE request and transmit, at 1610, a measurement report after measuring the downlink reference signal and using at least a part of the resources allocated for mobility reporting in response to the UE request. The measurement report may include measurement information for one or more of the source node or the at least one target node. For example, referring to FIG. 8, the UE 802 may be further configured to receive, at 818, the downlink reference signal in response to the UE request and transmit, at 824, a measurement report after measuring the downlink reference signal and using at least a part of the resources allocated for mobility reporting in response to the UE request. The measurement report may include measurement information for one or more of the source node 804 or the at least one target node (806, 808). In some aspects, 1608 and 1610 may be performed by the mobility enhancement component 198.

In some aspects, the downlink reference signal may be aperiodic or periodic and may include at least one of: an NCD-SSB, a PRS, a CSI-RS, or a TRS. For example, referring to FIG. 8, when the UE 802 receives, at 818, the DL RS from the source node 804, the DL RS may be aperiodic or periodic, and may include at least one of: an NCD-SSB, a PRS, a CSI-RS, or a TRS.

In some aspects, the UE request may be indicated in at least one of: an uplink reference signal, an uplink sequence, an uplink control channel, or an uplink data channel, and the configuration, the allocation, or the activation in response to the UE request may be included in DCI, an RRC message, a MAC-CE, or a combination thereof. For example, referring to FIG. 8, the UE request (the UE 802 sends, at 810, to the source node 804) may be indicated in at least one of: an uplink reference signal, an uplink sequence, an uplink control channel, or an uplink data channel, and the configuration, the allocation, or the activation in response to the UE request (the UE 802 receives at 816) may be included in DCI, an RRC message, a MAC-CE, or a combination thereof.

In some aspects, the UE may be further configured to, at 1604, receive one or more configurations for the L1 measurement, the L2 measurement, or the L3 measurement. The UE may receive the activation of one of the one or more configurations in response to the UE request. For example, referring to FIG. 8, the UE 802 may be further configured to receive, at 816, one or more configurations for the L1 measurement, the L2 measurement, or the L3 measurement. The UE may receive the activation of one of the one or more configurations in response to the UE request (the UE 802 sends at 810). In some aspects, 1604 may be performed by the mobility enhancement component 198.

In some aspects, the UE request may be for the mobility reporting resources to report one or more of: a mobility measurement report, a status of a BWP inactivity timer, a status of a mobility timer, or a condition to trigger or reset a mobility timer or a BWP inactivity timer. The UE may be further configured to receive, at 1612, at least one of the mobility measurement report, the status of the BWP inactivity timer, the status of the mobility timer, or the condition to trigger or reset the mobility timer or the BWP inactivity timer. For example, referring to FIG. 8, the UE request (the UE 802 sent at 810) may be for the mobility reporting resources to report one or more of: the mobility measurement report, the status of a BWP inactivity timer, the status of the mobility timer, or the condition to trigger or reset a mobility timer or the BWP inactivity timer. Referring to FIG. 9. The UE 902 may be further configured to receive at least one of the mobility measurement report (at 916), the status of the BWP inactivity timer (at 918), the status of the mobility timer, or the condition to trigger or reset the mobility timer or the BWP inactivity timer. In some aspects, 1612 may be performed by the mobility enhancement component 198.

In some aspects, the UE may be further configured to receive, at 1614, an indication for the UE to reset the BWP inactivity timer or the mobility timer, or receive, at 1616, additional information for mobility measurement or mobility of the UE. The additional information may include at least one of an on-demand reference signal transmission or on-demand reference signal activation, or update information for at least one target node. For example, referring to FIG. 9, the UE 902 may be further configured to receive, at 920, an indication for the UE to reset the BWP inactivity timer or the mobility timer, or receive additional information, at 922, for mobility measurement or mobility of the UE. The additional information may include at least one of an on-demand reference signal transmission or on-demand reference signal activation, or update information for at least one target node. In some aspects, 1614 and 1616 may be performed by the mobility enhancement component 198.

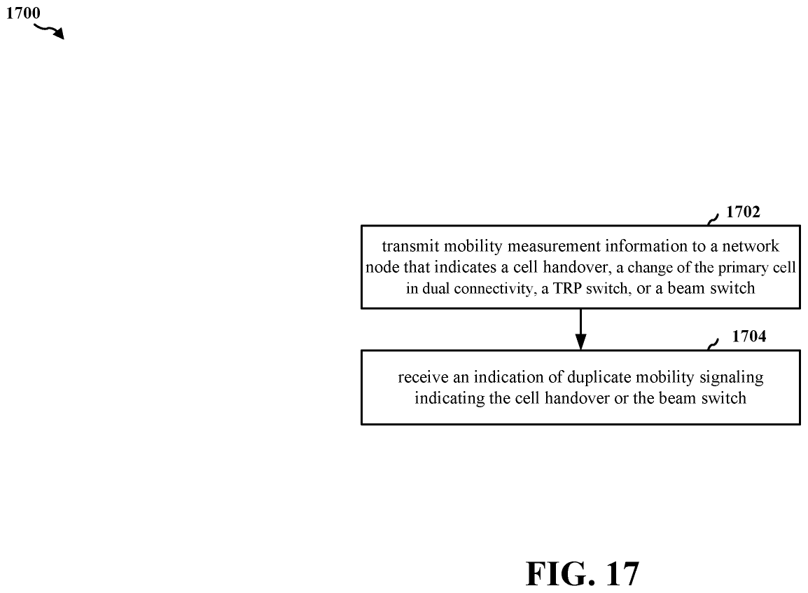

FIG. 17 is a flowchart 1700 illustrating methods of wireless communication at a UE in accordance with various aspects of the present disclosure. The method may be performed by a UE in the context of a target node and a source node, in various aspects. The UE may be the UE 104, 350, 802, 902, 1002, or the apparatus 1804 in the hardware implementation of FIG. 18. The source node may be a source base station, and the target node may be a target base station, in some aspects. In other aspects, the source node may be a source TRP, and the target node may be a target TRP. The source TRP and target TRP may be for the same base station or may be for different base stations. In some aspects, the source node may be a first component of a base station, and the target node may be a second component of the same base station or of a different base station. The base station may be the base station, or a component of the base station, in the access network of FIG. 1 or a core network component (e.g., base station 102, 310; or the network entity 1802 in the hardware implementation of FIG. 18). The method improves the flexibility and reliability in handling a UE's request for mobility measurement sources or mobility reporting resources. Thus, it improves the efficiency of wireless communication.

As shown in FIG. 17, at 1702, the UE may transmit mobility measurement information to a network node that indicates a cell handover, a change of the primary cell in dual connectivity, a TRP switch, or a beam switch. The network node may be a base station, or a component of a base station, in the access network of FIG. 1 or a core network component (e.g., base station 102, 310; source node 1004; or the network entity 1802 in the hardware implementation of FIG. 18). FIGS. 8, 9, and 10 illustrate various aspects of the steps in connection with flowchart 1700. For example, referring to FIG. 10, the UE 1002 may transmit, at 1008, mobility measurement information to a network node (source node 1004) that indicates a cell handover, the change of the primary cell in dual connectivity, the TRP switch, or the beam switch. In some aspects, 1702 may be performed by the mobility enhancement component 198.

At 1704, the UE may receive an indication of duplicate mobility signaling indicating the cell handover, the change of the primary cell in dual connectivity, the TRP switch, or the beam switch. For example, referring to FIG. 10, the UE 1002 may receive, at 1010, an indication of duplicate mobility signaling indicating the cell handover, the change of the primary cell in dual connectivity, the TRP switch, or the beam switch. In some aspects, 1704 may be performed by the mobility enhancement component 198.

In some aspects, the indication of the duplicate mobility signaling may be provided based on a measurement from the UE or a timer status of the UE. For example, referring to FIG. 10, when the UE 1002 receives, at 1010, the indication of the duplication mobility signaling from the source node 1004, the indication may be provided based on a measurement from the UE 1002 or a timer status of the UE 1002.

In some aspects, the indication of the duplicate mobility signaling may be included in at least one of: DCI, an RRC message, a MAC-CE, a sequence, or a reference signal. For example, referring to FIG. 10, when the UE 1002 receives, at 1010, the indication of the duplication mobility signaling from the source node 1004, the indication of the duplicate mobility signaling may be included in at least one of: DCI, an RRC message, a MAC-CE, a sequence, or a reference signal.

In some aspects, the duplicate mobility signaling may include a command for the cell handover, a change of the primary cell in dual connectivity, a TRP switch, or the beam switch duplicated in multiple BWPs during a window of time. The window may start from a reference time associated with UE's reception of the mobility signaling. The multiple BWPs may include an active downlink BWP and a default downlink BWP of a source node. The time window may start from a reference time associated with UE's reception of mobility signaling. For example, referring to FIG. 10, when the UE 1002 receives, at 1010, the indication of the duplication mobility signaling from the source node 1004, the duplicate mobility signaling may include a command for the cell handover, the change of the primary cell in dual connectivity, the TRP switch, or the beam switch duplicated in multiple BWPs during a window of time. The window may start from a reference time associated with UE 1002's reception of the mobility signaling. The multiple BWPs may include an active downlink BWP and a default downlink BWP of the source node 1004. The time window may start from a reference time associated with UE 1002's reception of mobility signaling.

In some aspects, the duplicate mobility signaling may include joint transmission from a source node and a target node in an SFN transmission scheme. For example, referring to FIG. 10, when the UE 1002 receives, at 1010, the indication of the duplication mobility signaling from the source node 1004, the duplicate mobility signaling may include joint transmission from the source node 1004 and a target node in an SFN transmission scheme.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include at least one cellular baseband processor 1824 (also referred to as a modem) coupled to one or more transceivers 1822 (e.g., cellular RF transceiver). The cellular baseband processor(s) 1824 may include at least one on-chip memory 1824′. In some aspects, the apparatus 1804 may further include one or more subscriber identity modules (SIM) cards 1820 and at least one application processor 1806 coupled to a secure digital (SD) card 1808 and a screen 1810. The application processor(s) 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor(s) 1824 communicates through the transceiver(s) 1822 via one or more antennas 1880 with the UE 104 and/or with an RU associated with a network entity 1802. The cellular baseband processor(s) 1824 and the application processor(s) 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor(s) 1824 and the application processor(s) 1806 are each responsible for general processing, including the execution of software stored on the computer-readable medium/memory. The software, when executed by the cellular baseband processor(s) 1824/application processor(s) 1806, causes the cellular baseband processor(s) 1824/application processor(s) 1806 to perform the various functions described supra. The cellular baseband processor(s) 1824 and the application processor(s) 1806 are configured to perform the various functions described supra based at least in part of the information stored in the memory. That is, the cellular baseband processor(s) 1824 and the application processor(s) 1806 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1824/application processor(s) 1806 when executing software. The cellular baseband processor(s) 1824/application processor(s) 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor(s) 1824 and/or the application processor(s) 1806, and in another configuration, the apparatus 1804 may be the entire UE (e.g., see UE 350 of FIG. 3) and include the additional modules of the apparatus 1804.

As discussed supra, in some aspects, the component 198 may be configured to transmit a UE request for an on-demand allocation of mobility measurement resources or mobility reporting resources for the UE; and receive a configuration, allocation, or activation for the mobility measurement resources or the mobility reporting resources in response to the UE request. In some aspects, the component 198 may be configured to transmit mobility measurement information to a network node that indicates a cell handover, a change of the primary cell in dual connectivity, a TRP switch, or a beam switch; and receive an indication of duplicate mobility signaling indicating the cell handover, the change of the primary cell in dual connectivity, the TRP switch, or the beam switch. The component 198 may be further configured to perform any of the aspects described in connection with the flowcharts in FIG. 15 and FIG. 17, and/or performed by the UE 802, 902. 1002 in FIGS. 8, 9, and 10, respectively. The component 198 may be within the cellular baseband processor(s) 1824, the application processor(s) 1806, or both the cellular baseband processor(s) 1824 and the application processor(s) 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1804 may include a variety of components configured for various functions. In one configuration, the apparatus 1804, and in particular the cellular baseband processor(s) 1824 and/or the application processor(s) 1806, includes means for transmitting a UE request for an on-demand allocation of mobility measurement resources or mobility reporting resources for the UE, and means for receiving a configuration, allocation, or activation for the mobility measurement resources or the mobility reporting resources in response to the UE request. In one configuration, the apparatus 1804 may include means for transmitting mobility measurement information to a network node that triggers or indicates a cell handover, a change of the primary cell in dual connectivity, a TRP switch, or a beam switch, and means for receiving an indication of duplicate mobility signaling triggering or indicating the cell handover, the change of the primary cell in dual connectivity, the TRP switch, or the beam switch. The apparatus 1804 may further include means for performing any of the aspects described in connection with the flowcharts in FIG. 15 and FIG. 17, and/or aspects performed by the UE 802, 902, 1002 in FIGS. 8, 9, and 10, respectively. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

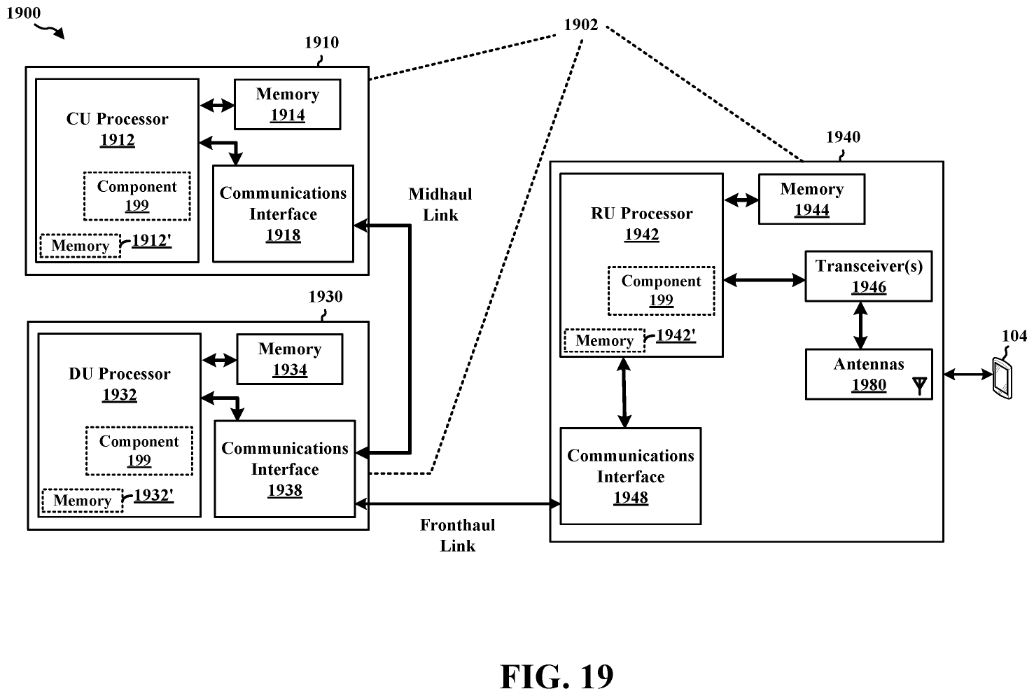

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include at least one CU processor 1912. The CU processor(s) 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include at least one DU processor 1932. The DU processor(s) 1932 may include on-chip memory 1932′. In some aspects, the DU 1930 may further include additional memory modules 1934 and a communications interface 1938. The DU 1930 communicates with the RU 1940 through a fronthaul link. The RU 1940 may include at least one RU processor 1942. The RU processor(s) 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium / memory may also be used for storing data that is manipulated by the processor(s) when executing software.

As discussed supra, in some aspects, the component 199 may be configured to receive a UE request for an on-demand allocation of mobility measurement resources or mobility reporting resources for a UE; and provide a configuration, allocation, or activation for the mobility measurement resources or the mobility reporting resources in response to the UE request. In some aspects, the component 199 may be configured to receive a request from a source node for a downlink reference signal configured for L1 or L3 measurement at a UE; and provide a reference signal configuration to the source node for the UE in response to the request. In some aspects, the component 199 may be configured to receive mobility measurement information from a UE that triggers or indicates a cell handover, a change of primary cell in dual connectivity, a TRP switch, or a beam switch; and provide an indication of duplicate mobility signaling triggering or indicating the cell handover, the change of primary cell in dual connectivity, the TRP switch, or the beam switch. The component 199 may be further configured to perform any of the aspects described in connection with the flowcharts in FIGS. 11, 13, and 14, and/or performed by the source node 804, 904, and 1004 in FIGS. 8, 9, and 10, respectively. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1902 may include a variety of components configured for various functions. In one configuration, the network entity 1902 includes means for receiving a UE request for an on-demand allocation of mobility measurement resources or mobility reporting resources for a UE, and means for providing a configuration, allocation, or activation for the mobility measurement resources or the mobility reporting resources in response to the UE request. In one configuration, the network entity 1902 may include means for receiving a request from a source node for a downlink reference signal configured for L1 or L3 measurement at a UE, and means for providing a reference signal configuration to the source node for the UE in response to the request. In one configuration, the network entity 1902 may include means for receiving mobility measurement information from a UE that triggers or indicates a cell handover, a change of the primary cell in dual connectivity, a TRP switch, or a beam switch, and means for providing an indication of duplicate mobility signaling triggering or indicating the cell handover, the change of the primary cell in dual connectivity, the TRP switch, or the beam switch. The network entity 1902 may further include means for performing any of the aspects described in connection with the flowcharts in FIGS. 11, 13, and 14, and/or aspects performed by the source node 804, 904, and 1004 in FIGS. 8, 9, and 10, respectively. The means may be the component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a source node. The method may include receiving a UE request for an on-demand allocation of mobility measurement resources or mobility reporting resources for a UE; and providing a configuration, allocation, or activation for the mobility measurement resources or the mobility reporting resources in response to the UE request. The method improves the flexibility and reliability in handling a UE's request for mobility measurement sources or mobility reporting resources. Thus, it improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a source node. The method may include receiving a UE request for an on-demand allocation of mobility measurement resources or mobility reporting resources for a UE; and providing a configuration, allocation, or activation for the mobility measurement resources or the mobility reporting resources in response to the UE request.

Aspect 2 is the method of aspect 1, where the request is for a downlink reference signal for L1 measurement, L2 measurement, or L3 measurement of the source node and at least one target node.

Aspect 3 is the method of any of aspects 1 to 2, where the method may further include transmitting the downlink reference signal and the resource allocation for mobility reporting in response to the UE request; and receiving a measurement report after measuring the downlink reference signal and using at least a part of the resources allocated for mobility reporting in response to the UE request. The measurement report may include measurement information for one or more of the source node or the at least one target node. The measurement report by the UE may use at least a part of the resources allocated for mobility reporting in response to the UE request.

Aspect 4 is the method of any of aspects 2 to 3, where the downlink reference signal may be aperiodic or periodic and may include at least one of: an NCD-SSB, a PRS, a CSI-RS, or a TRS.

Aspect 5 is the method of any of aspects 2 to 4, where the UE request may be indicated in at least one of: an uplink reference signal, an uplink sequence, an uplink control channel, or an uplink data channel.

Aspect 6 is the method of any of aspects 2 to 5, where the configuration, the allocation, or the activation in response to the UE request may be included in DCI, an RRC message, a MAC-CE, or a hybrid thereof.

Aspect 7 is the method of any of aspects 2 to 6, where the method may further include configuring one or more configurations for the L1 measurement, the L2 measurement, or the L3 measurement. The source node may activate one of the one or more configurations in response to the UE request.

Aspect 8 is the method of any of aspects 2 to 7, where the method may further include providing a request to the at least one target node for a target node resource for the L1 measurement, the L2 measurement, or the L3 measurement by the UE; and receiving a reference signal configuration from the at least one target node. The source node may provide the configuration in response to the UE request, and the configuration may include the reference signal configuration from the at least one target node.

Aspect 9 is the method of any of aspects 1 to 8, where the UE request may be for the mobility reporting resources to report one or more of: a mobility measurement report, an inactivity status of a BWP inactivity timer, the mobility status of the mobility timer, or a condition to trigger a mobility timer or the BWP inactivity timer. The method may further include receiving at least one of the mobility measurement report, the inactivity status of the BWP inactivity timer, the mobility status of the mobility timer, or the condition to trigger or reset the mobility timer or the BWP inactivity timer.

Aspect 10 is the method of aspect 9, where the method may further include providing an indication for the UE to reset the BWP inactivity timer or the mobility timer.

Aspect 11 is the method of aspect 9, where the method may further include providing additional information for mobility measurement or mobility of the UE. The additional information may include at least one of an on-demand reference signal transmission or on-demand reference signal activation, or update information for the at least one target node.

Aspect 12 is a method of wireless communication at a target node. The method may include receiving a request from a source node for a downlink reference signal configured for L1 or L3 measurement at a UE; and providing a reference signal configuration to the source node for the UE in response to the request.

Aspect 13 is an apparatus for wireless communication, including: at least one memory; and at least one processor coupled to the at least one memory and, based at least in part on information stored in the at least one memory, the at least one processor, individually or in any combination, is configured to perform the method of any of aspects 1-12.

Aspect 14 is the apparatus of aspect 13, further including at least one of a transceiver or an antenna coupled to the at least one processor and configured to receive the UE request or the request from the source node.

Aspect 15 is an apparatus for wireless communication including means for implementing the method of any of aspects 1-12.

Aspect 16 is a computer-readable medium (e.g., a non-transitory computer-readable medium) storing computer executable code for wireless communication at a node, where the code when executed by at least one processor causes the node to implement the method of any of aspects 1-12.

Aspect 17 is a method of wireless communication at a network entity. The method may include receiving mobility measurement information from a UE that triggers or indicates a cell handover, a change of the primary cell in dual connectivity, a TRP switch, or a beam switch; and providing an indication of duplicate mobility signaling triggering or indicating the cell handover, the change of the primary cell in dual connectivity, the TRP switch, or the beam switch.

Aspect 18 is the method of aspect 17, where the indication of the duplicate mobility signaling may be provided based on a measurement from the UE or a timer status of the UE.

Aspect 19 is the method of any of aspects 17 to 18, where the indication of the duplicate mobility signaling may be included in at least one of: DCI, an RRC message, a MAC-CE, a sequence, or a reference signal.

Aspect 20 is the method of any of aspects 17 to 19, where the duplicate mobility signaling may include a command for the cell handover, the change of the primary cell in dual connectivity, the TRP switch, or the beam switch duplicated in multiple BWPs during a window of time. The window may start from a reference time associated with UE's reception of the mobility signaling.

Aspect 21 is the method of aspect 20, where the multiple BWPs may include an active downlink BWP and a default downlink BWP of a source node.

Aspect 22 is the method of any of aspects 17 to 21, where the duplicate mobility signaling may include joint transmission from a source node and a target node in an SFN transmission scheme.

Aspect 23 is an apparatus for wireless communication at a network entity, including: at least one memory; and at least one processor coupled to the at least one memory and, based at least in part on information stored in the at least one memory, the at least one processor, individually or in any combination, is configured to cause the network entity to perform the method of any of aspects 17-22.

Aspect 24 is the apparatus of aspect 23, further including at least one of a transceiver or an antenna coupled to the at least one processor and configured to receive the mobility measurement information.

Aspect 25 is an apparatus for wireless communication including means for implementing the method of any of aspects 17-22.

Aspect 26 is a computer-readable medium (e.g., a non-transitory computer-readable medium) storing computer executable code for wireless communication at a network entity, where the code when executed by at least one processor causes the network entity to implement the method of any of aspects 17-22.

Aspect 27 is a method of wireless communication at a UE. The method may include transmitting a UE request for an on-demand allocation of mobility measurement resources or mobility reporting resources for the UE; and receiving a configuration, allocation, or activation for the mobility measurement resources or the mobility reporting resources in response to the UE request.

Aspect 28 is the method of aspect 27, where the request may be for a downlink reference signal for L1 measurement, L2 measurement, or L3 measurement of a source node and at least one target node.

Aspect 29 is the method of any of aspects 27 to 28, where the method may further include: receiving the downlink reference signal and the resource allocation for mobility reporting in response to the UE request; and transmitting a measurement report after measuring the downlink reference signal and using at least a part of the resources allocated for mobility reporting in response to the UE request. The measurement report may include measurement information for one or more of the source node or the at least one target node, and the measurement report by the UE may use at least a part of the resources allocated for mobility reporting in response to the UE request

Aspect 30 is the method of aspect 29, where the downlink reference signal may be aperiodic or periodic and may include at least one of: an NCD-SSB, a PRS, a CSI-RS, or a TRS.

Aspect 31 is the method of any of aspects 28 to 30, where the UE request may be indicated in at least one of: an uplink reference signal, an uplink sequence, an uplink control channel, or an uplink data channel, and the configuration, the allocation, or the activation in response to the UE request may be included in DCI, an RRC message, or a MAC-CE, or a hybrid thereof.

Aspect 32 is the method of any of aspects 28 to 31, where the method may further include receiving one or more configurations for the L1 measurement, the L2 measurement, or the L3 measurement, and the UE may receive the activation of one of the one or more configurations in response to the UE request.

Aspect 33 is the method of any of aspects 27 to 32, where the UE request may be for the mobility reporting resources to report one or more of: mobility measurement report, the inactivity status of a BWP inactivity timer, the mobility status of the mobility timer, or a condition to trigger or reset a mobility timer or a BWP inactivity timer. And the method may further include receiving at least one of the mobility measurement report, the inactivity status of the BWP inactivity timer, the mobility status of the mobility timer, or the condition to trigger or reset the mobility timer or the BWP inactivity timer.

Aspect 34 is the method of aspect 33, where the method may further include: receiving an indication for the UE to reset the BWP inactivity timer or the mobility timer, or receiving additional information for mobility measurement or mobility of the UE. The additional information may include at least one of an on-demand reference signal transmission or on-demand reference signal activation, or update information for at least one target node.

Aspect 35 is an apparatus for wireless communication at a UE, including: at least one memory; and at least one processor coupled to the at least one memory and, based at least in part on information stored in the at least one memory, the at least one processor is configured, individually or in any combination to cause the UE to perform the method of any of aspects 27-34.

Aspect 36 is the apparatus of aspect 35, further including at least one of a transceiver or an antenna coupled to the at least one processor and configured to transmit the UE request.

Aspect 37 is an apparatus for wireless communication including means for implementing the method of any of aspects 27-34.

Aspect 38 is a computer-readable medium (e.g., a non-transitory computer-readable medium) storing computer executable code for wireless communication at a UE, where the code when executed by at least one processor causes the UE to implement the method of any of aspects 27-34.

Aspect 39 is a method of wireless communication at a UE. The method may include transmitting mobility measurement information to a network node that triggers or indicates a cell handover, a change of the primary cell in dual connectivity, a TRP switch, or a beam switch; and receiving an indication of duplicate mobility signaling indicating the cell handover, the change of the primary cell, the TRP switch, or the beam switch.

Aspect 40 is the method of aspect 39, where the indication of the duplicate mobility signaling may be provided based on a measurement from the UE or a timer status of the UE.

Aspect 41 is the method of any of aspects 39 to 40, where the indication of the duplicate mobility signaling may be included in at least one of: DCI, an RRC message, a MAC-CE, a sequence, or a reference signal.

Aspect 42 is the method of any of aspects 39 to 41, where the duplicate mobility signaling may include a command for the cell handover, a change of the primary cell in dual connectivity, a TRP switch, or the beam switch duplicated in multiple BWPs during a window of time. The window may start from a reference time associated with UE's reception of the mobility signaling, and the multiple BWPs may include an active downlink BWP and a default downlink BWP of a source node. The time window may start from a reference time associated with UE's reception of mobility signaling.

Aspect 43 is the method of any of aspects 39 to 42, where the duplicate mobility signaling may include joint transmission from a source node and a target node in an SFN transmission scheme.

Aspect 44 is an apparatus for wireless communication at a UE, including: at least one memory; and at least one processor coupled to the at least one memory and, based at least in part on information stored in the at least one memory, the at least one processor, individually or in any combination, is configured to perform the method of any of aspects 39-43.

Aspect 45 is the apparatus of aspect 44, further including at least one of a transceiver or an antenna coupled to the at least one processor and configured to transmit the mobility measurement information.

Aspect 46 is an apparatus for wireless communication including means for implementing the method of any of aspects 39-43.

Aspect 47 is a computer-readable medium (e.g., a non-transitory computer-readable medium) storing computer executable code for wireless communication at a UE, where the code when executed by at least one processor causes the UE to implement the method of any of aspects 39-43.

What is claimed is:

1. An apparatus for wireless communication at a source node, comprising:
at least one memory; and
at least one processor coupled to the at least one memory and, based at least in part on information stored in the at least one memory, the at least one processor, individually or in any combination, is configured to cause the source node to:
receive a user equipment (UE) request for an on-demand allocation of mobility measurement resources or mobility reporting resources for a UE; and
provide a configuration, allocation, or activation for the mobility measurement resources or the mobility reporting resources in response to the UE request.

2. The apparatus of claim 1, further comprising a transceiver coupled to the at least one processor, wherein, to receive the UE request, the at least one processor, individually or in any combination, is configured to cause the source node to receive the UE request via the transceiver.

3. The apparatus of claim 1, wherein the UE request is for a downlink reference signal for layer 1 (L1) measurement or layer 3 (L3) measurement of the source node and at least one target node.

4. The apparatus of claim 3, wherein the at least one processor, individually or in any combination, is further configured to cause the source node to:
transmit the downlink reference signal and a resource allocation for mobility reporting in response to the UE request; and
receive a measurement report after transmitting the downlink reference signal, the measurement report including measurement information for one or more of the source node or the at least one target node, and wherein the measurement report by the UE uses at least a part of resources allocated in the resource allocation for the mobility reporting in response to the UE request.

5. The apparatus of claim 4, wherein the downlink reference signal is aperiodic or periodic and includes at least one of:
a non-cell defining synchronization signal block (NCD-SSB),
a positioning reference signal (PRS),
a channel state information reference signal (CSI-RS), or
a tracking reference signal (TRS).

6. The apparatus of claim 3, wherein the UE request is indicated in at least one of:
an uplink reference signal,
an uplink sequence,
an uplink control channel, or
an uplink data channel.

7. The apparatus of claim 3, wherein the configuration, the allocation, or the activation in response to the UE request is included in downlink control information (DCI), a radio resource control (RRC) message, a medium access control-control element (MAC-CE), or a combination thereof.

8. The apparatus of claim 3, wherein the at least one processor, individually or in any combination, is further configured to cause the source node to:
configure one or more configurations for the L1 measurement or the L3 measurement, wherein the source node activates one of the one or more configurations in response to the UE request.

9. The apparatus of claim 3, wherein the at least one processor, individually or in any combination, is further configured to cause the source node to:
provide a target request to the at least one target node for a target node resource for the L1 measurement or the L3 measurement by the UE; and
receive at least one reference signal configuration from the at least one target node, wherein the source node provides the at least one reference signal configuration in response to the UE request, the at least one reference signal configuration including a reference signal configuration from the at least one target node for the L1 measurement or the L3 measurement, or a combination thereof.

10. The apparatus of claim 1, wherein the UE request is for the mobility reporting resources to report one or more of:
a mobility measurement report,
an inactivity status of a bandwidth part (BWP) inactivity timer,
a mobility status of a mobility timer, or
a condition to trigger or reset the mobility timer or the BWP inactivity timer.

11. The apparatus of claim 10, wherein the at least one processor, individually or in any combination, is further configured to cause the source node to receive at least one of the mobility measurement report, the inactivity status of the BWP inactivity timer, the mobility status of the mobility timer, or the condition to trigger or reset the mobility timer or the BWP inactivity timer.

12. The apparatus of claim 11, wherein the at least one processor, individually or in any combination, is further configured to cause the source node to:
provide an indication for the UE to reset the BWP inactivity timer or the mobility timer.

13. The apparatus of claim 11, wherein the at least one processor, individually or in any combination, is further configured to cause the source node to:
provide additional information for mobility measurement or mobility of the UE, the additional information including at least one of an on-demand reference signal transmission or on-demand reference signal activation, or update information for at least one target node.

14. An apparatus for wireless communication at a target node, comprising:
at least one memory; and
at least one processor coupled to the at least one memory and, based at least in part on information stored in the at least one memory, the at least one processor, individually or in any combination, is configured to cause the target node to:
receive a request from a source node for a downlink reference signal configured for layer 1 (L1) or layer 3 (L3) measurement at a user equipment (UE); and
provide a reference signal configuration to the source node for the UE in response to the request.

15. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
transmit a user equipment (UE) request for an on-demand allocation of mobility measurement resources or mobility reporting resources for the UE; and
receive a configuration, allocation, or activation for the mobility measurement resources or the mobility reporting resources in response to the UE request.

16. The apparatus of claim 15, wherein the UE request is for a downlink reference signal for layer 1 (L1) measurement or layer 3 (L3) measurement of a source node and at least one target node.

17. The apparatus of claim 15, wherein the at least one processor, individually or in any combination, is further configured to cause the UE to:
receive a downlink reference signal in response to the UE request; and
transmit a measurement report after measuring the downlink reference signal and using at least a part of resources allocated for mobility reporting in response to the UE request, the measurement report including measurement information for one or more of a source node or at least one target node.

18. The apparatus of claim 17, wherein the downlink reference signal is aperiodic or periodic and includes at least one of:
a non-cell defining synchronization signal block (NCD-SSB),
a positioning reference signal (PRS),
a channel state information reference signal (CSI-RS), or
a tracking reference signal (TRS).

19. The apparatus of claim 16, wherein the UE request is indicated in at least one of:
an uplink reference signal,
an uplink sequence,
an uplink control channel, or
an uplink data channel.

20. The apparatus of claim 16, wherein the configuration, the allocation, or the activation in response to the UE request is included in downlink control information (DCI), a radio resource control (RRC) message, a medium access control-control element (MAC-CE), or a combination thereof.

21. The apparatus of claim 16, wherein the at least one processor, individually or in any combination, is further configured to cause the UE to:
receive one or more configurations for the L1 measurement or the L3 measurement, wherein the UE receives the activation of one of the one or more configurations in response to the UE request.

22. The apparatus of claim 15, wherein the UE request is for the mobility reporting resources to report one or more of:
a mobility measurement report,
an inactivity status of a bandwidth part (BWP) inactivity timer,
a mobility status of a mobility timer, or
a condition to trigger or reset the mobility timer or a BWP inactivity timer.

23. The apparatus of claim 22, wherein the at least one processor, individually or in any combination, is further configured to receive at least one of the mobility measurement report, the inactivity status of the BWP inactivity timer, the mobility status of the mobility timer, or the condition to trigger or reset the mobility timer or the BWP inactivity timer.

24. The apparatus of claim 23, wherein the at least one processor, individually or in any combination, is further configured to cause the UE to:
receive an indication for the UE to reset the BWP inactivity timer or the mobility timer.

25. The apparatus of claim 23, wherein the at least one processor, individually or in any combination, is further configured to cause the UE to:
receive additional information for mobility measurement or mobility of the UE, the additional information including at least one of an on-demand reference signal transmission or on-demand reference signal activation, or update information for at least one target node.

26. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
transmit mobility measurement information to a network node that triggers or indicates a cell handover, a change of a primary cell in dual connectivity, a TRP switch, or a beam switch; and
receive an indication of duplicate mobility signaling triggering or indicating the cell handover, the change of the primary cell, the TRP switch, or the beam switch.

27. The apparatus of claim 26, wherein the indication of the duplicate mobility signaling is provided based at least on a measurement from the UE or a timer status of the UE.

28. The apparatus of claim 26, wherein the indication of the duplicate mobility signaling is included in at least one of:
downlink control information (DCI),
a medium access control-control element (MAC-CE),
a radio resource control (RRC) message,
a sequence, or
a reference signal.

29. The apparatus of claim 26, wherein the duplicate mobility signaling includes a command for the cell handover, the change of the primary cell, the TRP switch, or the beam switch duplicated in multiple bandwidth parts (BWPs) during a window of time, wherein the multiple BWPs includes an active downlink BWP and a default downlink BWP of a source node, and the window of time starts from a reference time associated with UE's reception of mobility signaling.

30. The apparatus of claim 26, wherein the duplicate mobility signaling includes joint transmission from a source node and at least a target node in a single frequency network (SFN) transmission scheme.
